(19) United States
(12) Patent Application Publication
(10) Pub. No.: US 2026/0312165 A1
(43) Pub. Date: Oct. 8, 2026

(54) METHOD FOR DISASSEMBLING ELECTRODE ASSEMBLY AND DEVICE FOR DISASSEMBLING ELECTRODE ASSEMBLY

(71) Applicant: Prime Planet Energy & Solutions, Inc., Tokyo (JP)

(72) Inventors: Yozo UCHIDA, Toyota-shi (JP); Kazuhiko HASHIMOTO, Koriyama-shi, Fukushima-ken (JP); Keita YAMADA, Koriyama-shi (JP); Masayuki KUROTAKI, Koriyama-shi (JP); Taku KITAYAMA, Koriyama-shi (JP)

(21) Appl. No.: 19/639,307

(22) Filed: Apr. 6, 2026

(30) Foreign Application Priority Data
Apr. 8, 2025 (JP) 2025-063649

(51) Int. Cl. H01M 10/54

(52) U.S. Cl. CPC H01M 10/54

(57) ABSTRACT

A method for disassembling an electrode assembly disclosed here includes: preparing an electrode assembly formed by stacking a strip-like first separator, a strip-like negative electrode, a strip-like second separator, and a strip-like positive electrode in this order and winding the stack in a predetermined winding direction; separating the electrode assembly into the first separator and the negative electrode, and the second separator and the positive electrode at a winding end portion of the electrode assembly; and pulling the first separator and the second separator, respectively, to unwind the electrode assembly. The unwinding includes applying an impact to at least one of the unwound first separator and the unwound second separator.

### CROSS REFERENCE TO RELATED APPLICATION

The present application claims priority based on Japanese Patent Application No. 2025-063649 filed on Apr. 8, 2025, the entire contents of which are incorporated herein by reference.

### BACKGROUND OF THE DISCLOSURE

### 1. Field

The present invention relates to a method for disassembling an electrode assembly and an electrode assembly disassembly device.

### 2. Background

Japanese Patent Application Publication No. 2013-004299, for example, discloses a method for recycling a lithium-ion secondary battery. According to the disclosure of Japanese Patent Application Publication No. 2013-004299, the lithium-ion secondary battery includes a wound body formed by stacking and winding a positive electrode made of aluminum foil coated with an active material and a negative electrode made of copper foil coated with an active material, separated by a separator made of plastic foil. The lithium-ion secondary battery disclosed in Japanese Patent Application Publication No. 2013-004299 includes sealed stainless steel container, which houses the wound body and a non-aqueous electrolyte. Japanese Patent Application Publication No. 2013-004299 also discloses a method for crushing a lithium-ion secondary battery that has undergone pretreatment, such as discharge and cleaning, by feeding the battery into a crusher, and then recovering the materials of the crushed lithium-ion secondary battery by sorting the materials using air classification and a two-stage sieve.

Japanese Patent Application Publication No. 2007-165136 discloses a wound electrode body disassembly device configured to separately recover the positive electrode and negative electrode of a wound electrode body used in cylindrical lithium secondary batteries. According to Japanese Patent Application Publication No. 2007-165136, reusing the electrode materials from discarded lithium secondary batteries as battery materials contributes to the effective utilization of resources, and because of this, the electrode materials must be refined to a high purity. According to Japanese Patent Application Publication No. 2007-165136, to refine the electrode materials to a high purity, it is first necessary to simplify the process of separating the positive electrode and the negative electrode, which include scarce natural resources.

Japanese Patent Application Publication No. 2007-165136 discloses a wound electrode body disassembly device including a pay-off roller rotatably supporting a wound electrode body, a clamp roller for unwinding a positive electrode, a negative electrode, and separators from the wound electrode body supported by the pay-off roller, and a take-up roller for separately winding the positive electrode, the negative electrode, and the separators. According to Japanese Patent Application Publication No. 2007-165136, when setting the wound electrode body onto the wound electrode body disassembly device, the operator manually pulls out a laminated stack of the positive electrode, the negative electrode, and the separator from the wound electrode body and clamps the laminated stack with the clamp roller. Then, the operator separates the negative electrode, a separator A, the positive electrode, and a separator B from the clamp roller position and mounts them onto their respective winding rollers.

For a method of disassembling an electrode assembly formed by stacking a strip-like first separator, negative electrode, second separator, and positive electrode in this order and winding the stack, the present inventors devised a method of, separating the electrode assembly into the first separator and the negative electrode, and the second separator and the positive electrode at a winding end portion of the electrode assembly, and unwinding the electrode assembly by pulling the first separator and the second separator, respectively. When disassembling an electrode assembly with this method, the present inventors found that the electrode assembly becomes difficult to unwind in a latter stage of the unwinding process.

### SUMMARY

The present disclosure proposes a method for disassembling an electrode assembly by separating the electrode assembly into a first separator and negative electrode, and a second separator and positive electrode, and unwinding the electrode assembly by pulling the first separator and the second separator, respectively, in which portions of the electrode assembly that are difficult to unwind can be unwound more effectively. The present disclosure also proposes a device for disassembling an electrode assembly with which portions of the electrode assembly that are difficult to unwind can be unwound more effectively.

According to an aspect of the disclosure, there is provided a method for disassembling an electrode assembly, the method including: preparing an electrode assembly formed by stacking a strip-like first separator, a strip-like negative electrode, a strip-like second separator, and a strip-like positive electrode in this order and winding the stack in a predetermined winding direction; separating the electrode assembly into the first separator and the negative electrode, and the second separator and the positive electrode at a winding end portion of the electrode assembly; and pulling the first separator and the second separator, respectively, to unwind the electrode assembly; in which the unwinding includes applying an impact to at least one of the unwound first separator and the unwound second separator.

According to the findings of the present inventors, in the latter stage of unwinding, the main reason why it becomes difficult to separate the laminated sheet of the first separator and the negative electrode from the laminated sheet of the second separator and the positive electrode is that, when unwinding a region near an innermost circumference portion of the electrode assembly, the force line representing a force pulling the first separator and the force line representing the force pulling the second separator substantially overlap, making it difficult for a rotational force to act on the electrode assembly. According to the method for disassembling an electrode assembly described above, applying impact to at least one of the unwound first separator and the unwound second separator generates a force that peels apart the laminated sheet of the first separator and the negative electrode from the laminated sheet of the second separator and the positive electrode. Therefore, portions that are difficult to unwind, such as regions near the innermost circumference portion of the electrode assembly, can be unwound more effectively.

According to an aspect of the disclosure, there is provided a device for disassembling an electrode assembly configured to disassemble an electrode assembly formed by stacking a strip-like first separator, a strip-like negative electrode, a strip-like second separator, and a strip-like positive electrode in this order and winding the stack in a predetermined winding direction, the device including: a first pulling device configured to pull the first separator; a second pulling device configured to pull the second separator; and an impact application device configured to apply impact to at least one of the first separator pulled by the first pulling device and the second separator pulled by the second pulling device.

The device for disassembling an electrode assembly described above can achieve the same effects as the method for disassembling an electrode assembly described above.

### BRIEF DESCRIPTION OF THE DRAWINGS

FIG. 1 is a partially sectioned perspective view of an electrode assembly;

FIG. 2 is a perspective view of an electrode assembly disassembly device;

FIG. 3 is a perspective view of an electrode assembly housing section;

FIG. 4 is a perspective view of a first separation device;

FIG. 5 is a perspective view of the first separation device with a scraper inserted into a deflected portion of a transport path;

FIG. 6 is a front view of the first separation device with the scraper inserted into the deflected portion of the transport path;

FIG. 7 is a perspective view of a second separation device;

FIG. 8 is a perspective view of the second separation device with a peeling roll lowered;

FIG. 9 is a perspective view illustrating an impact application device;

FIG. 10A is a flowchart showing a disassembly process for an electrode assembly;

FIG. 10B is a flowchart showing the disassembly process for an electrode assembly;

FIG. 10C is a flowchart showing the disassembly process for an electrode assembly;

FIG. 11 is a perspective view of a first transport unit and the first separation device while transporting a first separator sheet;

FIG. 12 is a side view of a second transport unit and the second separation device while transporting a second separator sheet;

FIG. 13 is a schematic front view of the electrode assembly in a state where the second separator sheet is pulled;

FIG. 14 is a schematic left side view illustrating an impact application device according to a first modification;

FIG. 15 is a schematic left side view illustrating an impact application device according to a second modification.

### DETAILED DESCRIPTION OF THE PREFERRED EMBODIMENTS

Hereinafter, an embodiment of an electrode assembly disassembly device will be described. It is needless to say that the embodiments described herein are not intended to specifically limit the disclosure. Each drawing is drawn schematically and does not necessarily reflect the actual objects. Moreover, in each drawing, members and parts having the same function will be given the same reference numerals, and redundant description thereof will be omitted or simplified.

As used herein, the term “power storage device” refers to any device from which electrical energy can be taken out. In addition to both primary and secondary batteries, the term “power storage device” also includes chemical batteries such as lithium-ion secondary batteries and nickel-metal hydride batteries, as well as physical batteries such as electric double-layer capacitors.

### Electrode Assembly Configuration

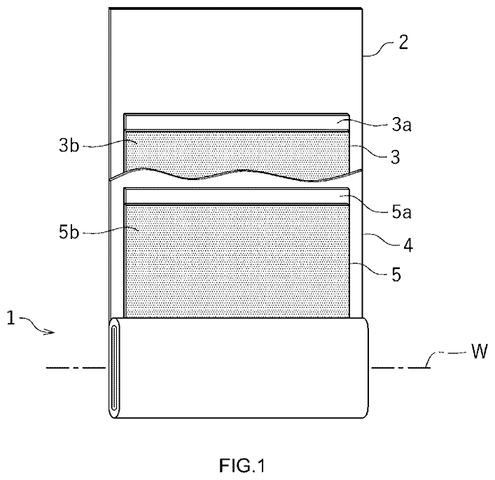

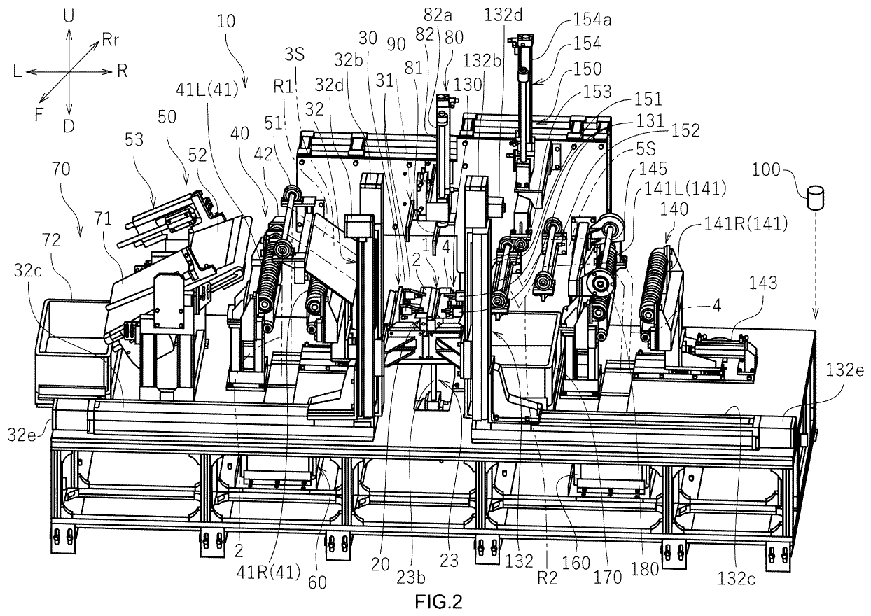

FIG. 1 is a partially sectioned perspective view of an electrode assembly 1 according to one embodiment. The electrode assembly 1 is the object to be disassembled by an electrode assembly disassembly device 10 (see FIG. 2) according to this embodiment. In this embodiment, the electrode assembly 1 has been removed from the power storage device, which includes a battery case, in which it was housed, electrode terminals, and electrolyte. The type of the electrode assembly 1 is not particularly limited. For example, the electrode assembly 1 may be an electrode assembly of a lithium-ion secondary battery. Various methods for removing the electrode assembly 1 from the power storage device have been proposed, and the method is not particularly limited.

As illustrated in FIG. 1, the electrode assembly 1 includes a strip-like first separator sheet 2, a strip-like negative electrode sheet 3, a strip-like second separator sheet 4, and a strip-like positive electrode sheet 5, which are stacked in this order and wound in a predetermined winding direction. The electrode assembly 1 is a so-called wound electrode assembly. In this embodiment, the electrode assembly 1 is wound in a direction from the outermost periphery, in the order of the first separator sheet 2, the negative electrode sheet 3, the second separator sheet 4, and the positive electrode sheet 5. The first separator sheet 2 and the second separator sheet 4 are configured to have a longer longitudinal length (in the winding circumferential direction) than the negative electrode sheet 3 and the positive electrode sheet 5. A winding end portion of the electrode assembly 1 corresponds to the first separator sheet 2 and the second separator sheet 4.

The first separator sheet 2 and the second separator sheet 4 may be made, for example, of a porous resin sheet that has required heat resistance and allows electrolytes to pass through. The material of the first separator sheet 2 and the second separator sheet 4 is not particularly limited. The first separator sheet 2 and the second separator sheet 4 are sandwiched between the positive electrode sheet 5 and the negative electrode sheet 3, insulating the positive electrode sheet 5 from the negative electrode sheet 3. The first separator sheet 2 and the second separator sheet 4 may be adhesive separators with adhesive applied to both surfaces. In this case, the first separator sheet 2, the negative electrode sheet 3, the second separator sheet 4, and the positive electrode sheet 5 are bonded together.

The negative electrode sheet 3 includes a negative electrode current collector foil 3a and a negative electrode active material layer 3b formed on the negative electrode current collector foil 3a. The negative electrode sheet 3 is a sheet in which the negative electrode active material layer 3b, which contains a negative electrode active material, is formed on the surface of the negative electrode current collector foil 3a. In this embodiment, the negative electrode current collector foil 3a is made of copper foil with a predetermined width and thickness. The negative electrode active material is a material such as natural graphite that is capable of adsorbing lithium ions during charging and releasing the adsorbed lithium ions during discharging. The negative electrode active material is not limited to natural graphite, and various other negative electrode active materials have been generally proposed. When the power storage device is a device other than a lithium-ion secondary battery, the negative electrode sheet 3 may include various negative electrode current collector foils 3a and negative electrode active material layers 3b corresponding to the type of power storage device.

The positive electrode sheet 5 includes a positive electrode current collector foil 5a and a positive electrode active material layer 5b formed on the positive electrode current collector foil 5a. The positive electrode sheet 5 is a sheet in which the positive electrode active material layer 5b, which contains a positive electrode active material, is formed on the surface of the positive electrode current collector foil 5a. In this embodiment, the positive electrode current collector foil 5a is made of aluminum foil of a predetermined width and thickness. The positive electrode active material is a material such as a lithium transition metal composite material that is capable of releasing lithium ions during charging and absorbing lithium ions during discharging. The positive electrode active material is not limited to a lithium transition metal composite material, and various other positive electrode active materials have been generally proposed. When the power storage device is a device other than a lithium-ion secondary battery, the positive electrode sheet 5 may include various positive electrode current collector foils 5a and positive electrode active material layers 5b corresponding to the type of power storage device.

### Overview of Electrode Assembly Disassembly Device

FIG. 2 is a perspective view of the electrode assembly disassembly device 10. For convenience, the left-right direction in FIG. 2 shall be referred to as “the left-right direction,” and the depth direction in FIG. 2 shall be referred to as “the front-rear direction.” In the drawings, front, rear, left, right, top, and bottom are represented by the symbols F, Rr, L, R, U, and D, respectively. As illustrated in FIG. 2, the electrode assembly disassembly device 10 includes an electrode assembly housing section 20, a first gripping unit 30, a first transport unit 40, a first separation device 50, a first separator recovery section 60, a negative electrode sheet recovery section 70, a second gripping unit 130, a second transport unit 140, a second separation device 150, a second separator recovery section 160, a positive electrode sheet recovery section 170, a positive and negative electrode separation device 80, an impact application device 90, a tension detection device 180, and a controller 100.

The electrode assembly 1 is set in the electrode assembly housing section 20 prior to disassembly. The electrode assembly disassembly device 10 is configured to unwind the wound electrode assembly 1 by pulling both the first separator sheet 2 and the second separator sheet 4 of the electrode assembly 1. During the unwinding process, the electrode assembly 1 rotates within the electrode assembly holding section 20, generally around a winding axis W (see FIG. 1).

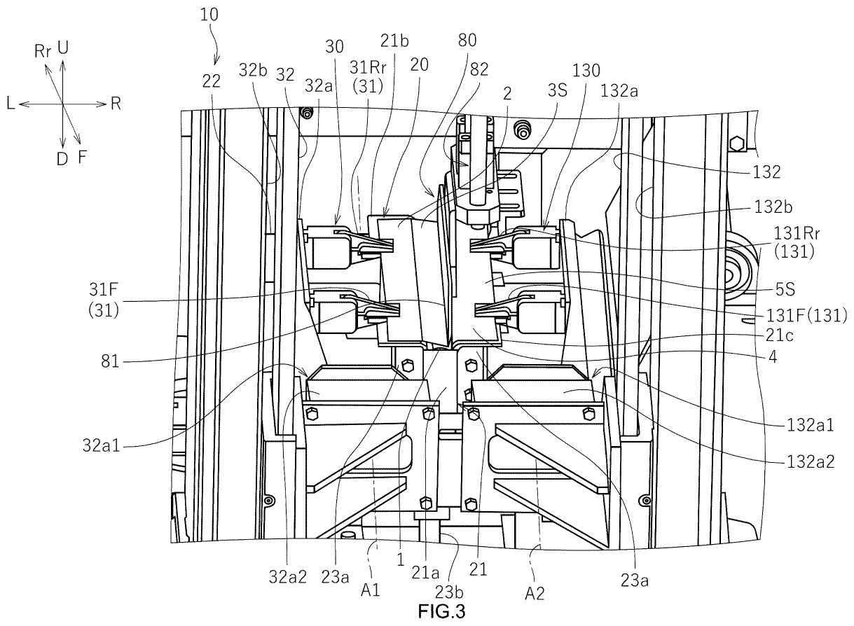

The first gripping unit 30 grips a winding end portion of the first separator sheet 2 that extends outside the electrode assembly housing portion 20. The negative electrode sheet 3 is adhered to the first separator sheet 2. Because the negative electrode sheet 3 has a shorter longitudinal length than the first separator sheet 2, the winding end portion of a laminated sheet formed by the first separator sheet 2 and the negative electrode sheet 3 (hereinafter also referred to as “negative electrode laminated sheet 3S,” see FIG. 3) consists solely of the first separator sheet 2. The first gripping unit 30 grips and moves a terminal portion of the first separator sheet 2 during the initial stage of unwinding the electrode assembly 1, and mounts the first separator sheet 2 onto the first transport unit 40. In this embodiment, the first gripping unit 30 is disposed to the left of the electrode assembly housing portion 20.

The first transport unit 40 grips the first separator sheet 2 between a pair of nip rolls 41 and transports the first separator sheet 2 by rotating the pair of nip rolls 41. The first transport unit 40 is disposed further to the left of the first gripping unit 30. The first separation device 50 separates the negative electrode sheet 3 from the first separator sheet 2 on a transport path R1 of the first separator sheet 2, upstream of the first transport unit 40 (on the side of the electrode assembly housing section 20). Thus, the first transport unit 40 transports only the first separator sheet 2 by the pair of nip rolls 41. The first separator sheet 2 is conveyed by the first transport unit 40 to the first separator recovery section 60. The negative electrode sheet 3 separated from the first separator sheet 2 advances as the first separator sheet 2 is conveyed, and is recovered in the negative electrode sheet recovery section 70, which is disposed beyond the first separation device 50.

The second gripping unit 130 grips a winding end portion of the second separator sheet 4 that extends outside the electrode assembly housing portion 20. The positive electrode sheet 5 is adhered to the second separator sheet 4. Because the positive electrode sheet 5 has a shorter longitudinal length than the second separator sheet 4, the winding end portion of a laminated sheet formed by the second separator sheet 4 and the positive electrode sheet 5 (hereinafter also referred to as “positive electrode laminated sheet 5S,” see FIG. 3) consists solely of the second separator sheet 4. The second gripping unit 130 grips and moves a terminal portion of the second separator sheet 4 during the initial stage of unwinding the electrode assembly 1, and mounts the second separator sheet 4 onto the second transport unit 140. In this embodiment, the second gripping unit 130 is disposed to the right of the electrode assembly housing portion 20.

The second transport unit 140 grips the second separator sheet 4 between a pair of nip rolls 141 and transports the second separator sheet 4 by rotating the pair of nip rolls 141. The second transport unit 140 is disposed further to the right of the second gripping unit 130. The second separation device 150 separates the positive electrode sheet 5 from the second separator sheet 4 on a transport path R2 of the second separator sheet 4, upstream of the second transport unit 140 (on the side of the electrode assembly housing section 20). Thus, the second transport unit 140 transports only the second separator sheet 4 by the pair of nip rolls 141. The second separator sheet 4 is conveyed by the second transport unit 140 to the second separator recovery section 160. The positive electrode sheet 5 separated from the second separator sheet 4 falls into the positive electrode sheet recovery section 170, which is disposed below the second separation device 150.

The positive/negative electrode separation device 80 assists in separating the negative electrode laminated sheet 3S and the positive electrode laminated sheet 5S when the first gripping unit 30 pulls the negative electrode laminated sheet 3S and the second gripping unit 130 pulls the positive electrode laminated sheet 5S. The positive/negative electrode separation device 80 assists in separating the electrode assembly 1 into the negative electrode laminated sheet 3S and the positive electrode laminated sheet 5S by inserting a center scraper 81 between the negative electrode laminated sheet 3S and the positive electrode laminated sheet 5S. The positive/negative electrode separation device 80 is provided above the electrode assembly housing section 20.

The tension detection device 180 detects tension of the second separator sheet 4 that is pulled by the second transport unit 140. The electrode assembly disassembly device 10 detects that unwinding of the electrode assembly 1 has stopped and that the first separator sheet 2 and the second separator sheet 4 have become pulled, by detecting, with the tension detection device 180, tension applied to the second separator sheet 4.

The impact application device 90 applies an impact to the first separator sheet 2 pulled by the first transport unit 40, thereby peeling apart the negative electrode laminate sheet 3S and the positive electrode laminate sheet 5S of the electrode assembly 1 after unwinding has stopped. The impact application device 90 is disposed above the electrode assembly housing section 20. The impact application device 90 applies an impact to the first separator sheet 2 by causing a moving bar 91, which moves toward the first separator sheet 2, to collide with the first separator sheet 2.

### Electrode Assembly Housing Section

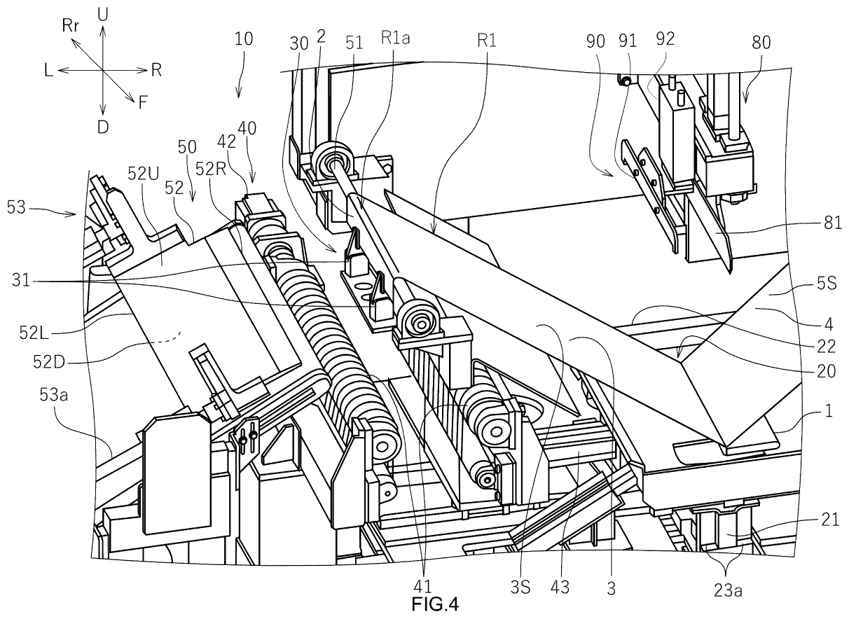

FIG. 3 is a perspective view of the electrode assembly housing section 20. As illustrated in FIG. 3, the electrode assembly housing section 20 includes a holding fixture 21, a rotary box 22 (see also FIG. 4), and a fixture lowering device 23 (see FIG. 2).

The holding fixture 21 holds the electrode assembly 1 at a stage before the negative electrode laminated sheet 3S is pulled by the first gripping unit 30 and the positive electrode laminated sheet 5S is pulled by the second gripping unit 130. As illustrated in FIG. 3, the holding fixture 21 includes a holding unit 21a configured to hold the electrode assembly 1 and a first placement portion 21b where the terminal portion of the first separator sheet 2 (negative electrode laminated sheet 3S) that extends outside the electrode assembly 1 is placed, and a second placement portion 21c where the terminal portion of the second separator sheet 4 (positive electrode laminated sheet 5S) that extends outside the electrode assembly 1 is placed. The holding unit 21a holds the electrode assembly 1 such that the winding axis W (see FIG. 1) faces substantially in the front-rear direction. The holding unit 21a holds the electrode assembly 1 such that a pair of wide faces face the left side (the side of the first gripping unit 30) and the right side (the side of the second gripping unit 130). The holding unit 21a is configured as a flat box-like member with a length in the left-right direction shorter than a length in the front-rear direction. The holding unit 21a has an open top face. The first placement portion 21b extends leftward from a left upper edge portion of the holding unit 21a. The negative electrode laminated sheet 3S is placed on the first placement portion 21b such that the negative electrode sheet 3 is positioned above the first separator sheet 2. The second placement portion 21c extends rightward from a right upper edge portion of the holding unit 21a. The positive electrode laminated sheet 5S is placed on the second placement section 21c such that the second separator sheet 4 is positioned above the positive electrode sheet 5.

The rotary box 22 is a box-like member that houses the electrode assembly 1 after the electrode assembly 1 has exited the holding fixture 21. The rotary box 22 has an open top face. The holding fixture 21 is set at a predetermined position within the rotary box 22. A positioning member 23a, which determines the set position of the holding fixture 21, will be explained when describing the fixture lowering device 23. The position of the holding fixture 21 determines the positions of the terminal portion of the first separator sheet 2 (negative electrode laminated sheet 3S) and the terminal portion of the second separator sheet 4 (positive electrode laminated sheet 5S). After exiting the holding fixture 21, the electrode assembly 1 rotates within the rotary box 22, generally around the winding axis W, as the first separator sheet 2, the negative electrode sheet 3, the second separator sheet 4, and the positive electrode sheet 5 are unwound. The length of the rotary box 22 in the left-right direction is longer than that of the rotational diameter of the electrode assembly 1 to allow the electrode assembly 1 to move in the left-right direction.

The fixture lowering device 23 lowers the holding fixture 21 below the rotary box 22 after the negative electrode laminated sheet 3S is gripped by the first gripping unit 30 and the positive electrode laminated sheet 5S is gripped by the second gripping unit 130 (see FIG. 4; in FIG. 4, the holding fixture 21 is lowered). When the holding fixture 21 is lowered, the electrode assembly 1 can rotate within the rotary box 22. The fixture lowering device 23 includes the positioning member 23a configured to support the holding fixture 21 and determine the set position of the holding fixture 21, and an air cylinder 23b (see FIG. 2) configured to support the positioning member 23a and extend/retracts in the up-down direction. However, the configuration of the fixture lowering device 23 is not particularly limited.

### Positive/Negative Electrode Separation Device

As illustrated in FIG. 3, the positive/negative electrode separation device 80 includes the center scraper 81 and a scraper lowering device 82. The center scraper 81 is a plate-like member that extends in the front-rear direction and the up-down direction. The scraper lowering device 82 is configured to lower the center scraper 81 such that a lower end of the center scraper 81 is inserted into the holding fixture 21, and to raise the center scraper 81 such that the lower end of the center scraper 81 withdraws from the holding fixture 21. As illustrated in FIG. 2, in this embodiment, the scraper lowering device 82 includes an air cylinder 82a that extends and retracts in the up-down direction. FIG. 3 illustrates a state where the center scraper 81 has been lowered. As illustrated in FIG. 3, when the center scraper 81 is lowered by the scraper lowering device 82, the center scraper 81 is inserted between the negative electrode laminated sheet 3S and the positive electrode laminated sheet 5S before the electrode assembly 1 is unwound.

### First Gripping Unit

As illustrated in FIG. 3, the first gripping unit 30 includes a pair of first clamps 31 and a first moving device 32. The pair of first clamps 31 grip the first separator sheet 2 (negative electrode laminated sheet 3S). The pair of first clamps 31 includes a front clamp 31F, and a rear clamp 31Rr that is disposed rearward of the front clamp 31F. The front clamp 31F grips the front side of the terminal portion of the first separator sheet 2. The rear clamp 31Rr grips the rear side of the terminal portion of the first separator sheet 2.

The first moving device 32 moves the pair of first clamps 31 along the predetermined transport path R1 of the first separator sheet 2 (see FIG. 2). Herein, the phrase “move along the transport path R1 of the first separator sheet 2” is not limited to moving along a path that exactly matches the transport path R1 of the first separator sheet 2 and broadly means moving so as to pass through a predetermined side of components (e.g., the pair of nip rolls 41 of the first transport unit 40, or a deflection roll 51 of the first separation device 50 to be described later, etc.) arranged along the transport path R1, such as between the pair of nip rolls 41 or above the deflection roll 51. In this embodiment, the path along which the first moving device 32 moves the pair of first clamps 31 is a path along the transport path R1 including passage between at least one pair of nip rolls 41. Details of the path along which the first moving device 32 moves the pair of first clamps 31 will be described later. The first gripping unit 30 grips the first separator sheet 2 with the pair of first clamps 31 and pulls the first separator sheet 2 by moving the pair of first clamps 31 via the first moving device 32.

As illustrated in FIG. 3, the first moving device 32 includes a support portion 32a configured to support the pair of first clamps 31, an up-down guide 32b configured to support the support portion 32a movably in the up-down direction, a left-right guide 32c (see FIG. 2) configured to support the up-down guide 32b movably in the left-right direction, an up-down movement motor 32d (see FIG. 2) configured to move the support portion 32a along the up-down direction guide 32b, and a left-right movement motor 32e (see FIG. 2) configured to move the up-down guide 32b along the left-right guide 32c.

As illustrated in FIG. 3, the support portion 32a extends in the front-rear direction. The support portion 32a includes a pivot device 32a1 configured to pivot the pair of first clamps 31 in the up-down direction. The pivot device 32a1 includes a pivot motor 32a2 including a rotation shaft that rotates about an axis A1 that is offset from base ends (here, the left ends) of the pair of first clamps 31 when viewed in the front-rear direction. The axis A1 of the rotation shaft of the pivot motor 32a2 extends in the front-rear direction. The pair of first clamps 31 pivot about the axis A1. The pivot device 32a1 allows the posture of the pair of first clamps 31 to be changed.

As illustrated in FIG. 2, the up-down guide 32b extends in the up-down direction. When the up-down movement motor 32d is driven, the support portion 32a and the pair of first clamps 31 supported on the support portion 32a are positioned vertically along the up-down guide 32b. The left-right guide 32c extends in the left-right direction. When the left-right movement motor 32e is driven, the up-down guide 32b, the support portion 32a, and the pair of first clamps 31 are positioned laterally along the left-right guide 32c. By combining the driving of the up-down movement motor 32d with the driving of the left-right movement motor 32e, the pair of first clamps 31 can be moved along a predetermined path in the front-rear direction.

### First Transportation Unit

As illustrated in FIG. 2, the first transport unit 40 includes the pair of nip rolls 41 that rotate while gripping the first separator sheet 2. The pair of nip rolls 41 includes a drive roll 41L, and a driven roll 41R disposed facing the drive roll 41L to the right of the drive roll 41L. The drive roll 41L and the driven roll 41R are each configured to rotate about an axis of rotation that extends in the front-rear direction. The first transport unit 40 includes a transport motor 42 configured to rotate the drive roll 41L. The transport motor 42 is a motor capable of controlling rotation speed or rotation torque. The transport motor 42 is, for example, a servo motor. The first transport unit 40 further includes a gripping cylinder 43 (see FIG. 4) configured to move the driven roll 41R in the left-right direction to move the driven roll 41R closer to or farther away from the drive roll 41L. The clamping cylinder 43 is an air cylinder that extends and retracts in the left-right direction. However, the actuator for moving the driven roll 41R in the left-right direction is not limited to an air cylinder and may be a motor, for example.

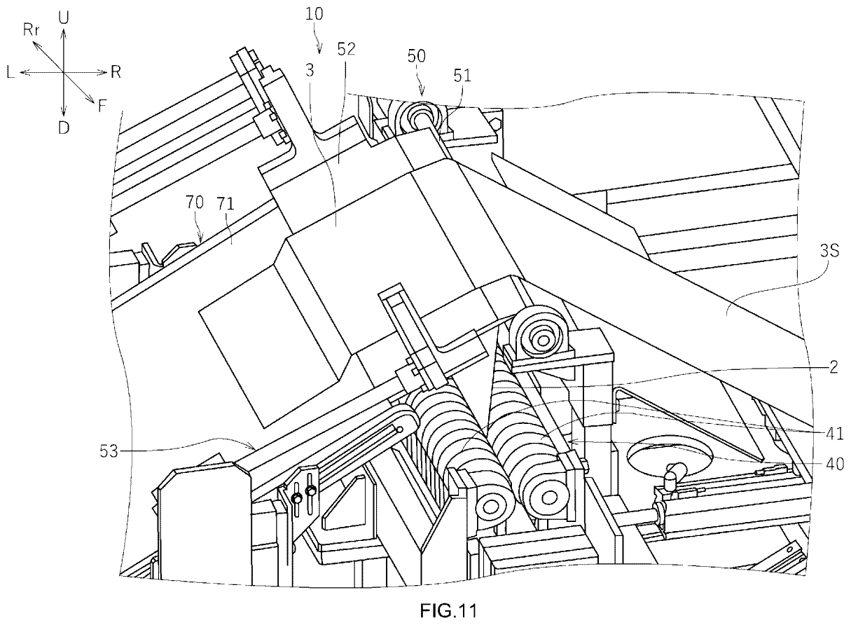

The first transport unit 40 drives the clamping cylinder 43 while the first separator sheet 2 is positioned between the drive roll 41L and the driven roll 41R, thereby clamping the first separator sheet 2 between the drive roll 41L and the driven roll 41R (see FIG. 11). When the transport motor 42 is driven, the drive roll 41L rotates such that the side facing the driven roll 41R moves downward, thereby conveying the first separator sheet 2 downward together with the driven roll 41R. The first transport unit 40 is an example of a first pulling device configured to pull the first separator sheet 2. However, the first pulling device is not limited to a device including a pair of nip rolls. The first pulling device may include, for example, a winding roll for winding up the first separator sheet 2 or an arm for pulling the first separator sheet 2. By being conveyed by the first transport unit 40, the first separator sheet 2 moves along the predetermined transport path R1. A first separator recovery section 60 is provided below the drive roll 41L and the driven roll 41R.

### First Separation Device

The first separation device 50 separates the negative electrode sheet 3 from the first separator sheet 2 on the transport path R1 of the first separator sheet 2, upstream of the first transport unit 40. FIG. 4 is a perspective view of the first separation device 50. As illustrated in FIG. 4, the first separation device 50 includes a deflection roll 51, a scraper 52, and a scraper insertion device 53.

The deflection roll 51 is provided on the transport path R1 of the first separator sheet 2 and deflects the transport path R1. The deflection roll 51 extends in the front-rear direction. The deflection roll 51 is configured to rotate about an axis of rotation extending in the front-rear direction. In this embodiment, the deflection roll 51 is disposed to the left of and above the rotary box 22 of the electrode assembly housing section 20. The first separator sheet 2 is wound onto the deflection roll 51 from above by the first gripping unit 30. Between the electrode assembly housing section 20 and the deflection roll 51, the first separator sheet 2 is conveyed diagonally upward to the left.

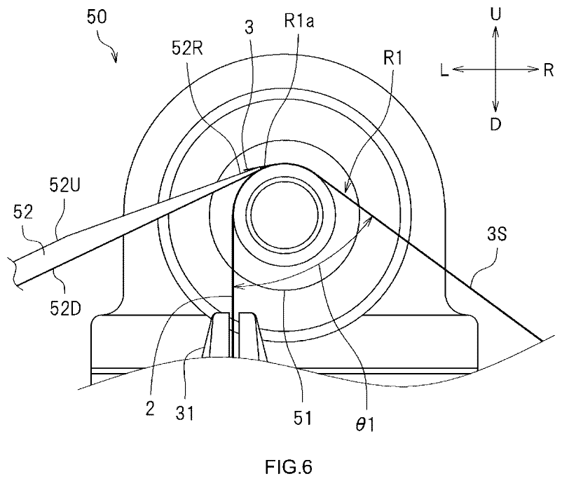

The deflection roll 51 is disposed above the pair of nip rolls 41 of the first transport unit 40. The deflection roll 51 deflects the transport path R1 of the first separator sheet 2 toward the pair of nip rolls 41 (in this case, downward). However, the direction in which the deflection roll 51 deflects the transport path R1 of the first separator sheet 2 is not particularly limited. The direction in which the deflection roll 51 deflects the transport path R1 of the first separator sheet 2 may, for example, be upward. An angle θ1 at which the deflection roll 51 deflects the transport path R1 (see FIG. 6; θ1 represents an interior angle, and a smaller θ1 indicates a sharper deflection angle) is not particularly limited and is, for example, 120 degrees or less. Note that reference numeral R1a indicates the deflected portion of the transport path R1.

The scraper 52 is a separation member configured to separate the first separator sheet 2 and the negative electrode sheet 3. The scraper 52 is configured as a plate that extends in the front-rear direction and the left-right direction and has an upper face 52U and a lower face 52D. The scraper 52 separates the first separator sheet 2 and the negative electrode sheet 3 on the upper face 52U side and the lower face 52D side. A tip portion 52R of the scraper 52 has a tapered shape such that, in a front view, the height in the up-down direction decreases toward the upstream side of the transport path R1 of the first separator sheet 2 (also see FIG. 6). In this embodiment, the upper face 52U of the scraper 52 is bent to form the tapered shape of the tip portion 52R. In this embodiment, the lower face 52D of the scraper 52 is planar. The width of the scraper 52 in the front-rear direction is longer than the width of the negative electrode sheet 3.

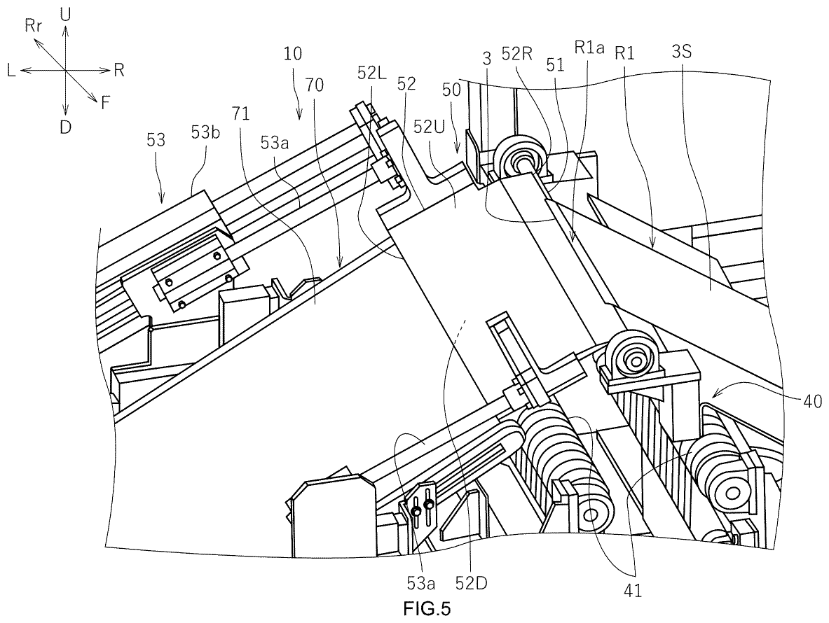

The scraper insertion device 53 inserts the scraper 52 into the deflected portion R1a of the transport path R1, or withdraws the scraper 52 from the deflected portion R1a. FIG. 5 is a perspective view of the first separation device 50 with the scraper 52 inserted into the deflected portion R1a of the transport path R1. As illustrated in FIGS. 4 and 5, at the right end position, the scraper 52 is disposed at the deflected portion R1a of the transport path R1 for the first separator sheet 2. The scraper insertion device 53 inserts the scraper 52 into the transport path R1 after the tip portion of the first separator sheet 2 has passed through the deflected portion R1a and before the tip portion of the negative electrode sheet 3 reaches the deflected portion R1a. Inserting the scraper 52 into the transport path R1 at this timing allows the first separator sheet 2 to be wound onto the deflection roll 51. Subsequently, as the first separator sheet 2 moves, the tip portion 52R of the scraper 52 enters the space between the first separator sheet 2 and the negative electrode sheet 3. When the negative electrode sheet 3 is peeled off the first separator sheet 2 by the scraper 52, the negative electrode sheet 3, which is above the first separator sheet 2, rests on the upper face 52U of the scraper 52. The first separator sheet 2, which is below the negative electrode sheet 3, is conveyed along the side of the lower face 52D of the scraper 52.

As illustrated in FIG. 5, the scraper insertion device 53 includes a pair of front-rear guide rods 53a and an insertion cylinder 53b. The insertion cylinder 53b is driven to cause the scraper 52 to approach or move away from the deflection roll 51 along the guide rods 53a. In this embodiment, the scraper insertion device 53 supports the scraper 52 at an angle such that the tip portion 52R of the scraper 52 is positioned higher than a base portion 52L of the scraper 52. The scraper 52 is inclined upward toward the right. The scraper insertion device 53 moves the scraper 52 diagonally upward and to the right, bringing it closer to the deflection roll 51. Driving the scraper insertion device 53 toward the approach side of the scraper 52 causes the scraper 52 to come into contact with the surface of the first separator sheet 2, which is wound around the deflection roll 51 (that is, come into contact with the deflection roll 51 via the first separator sheet 2).

FIG. 6 is a front view of the first separation device 50 with the scraper 52 inserted into the deflected portion R1a of the transport path R1. As illustrated in FIG. 6, in this embodiment, the scraper 52 comes into contact with a circumferential midpoint, or the vicinity of the midpoint, of the first separator sheet 2 within the range wound around the deflection roll 51. More specifically, the tip portion 52R of the scraper 52 or its vicinity comes into contact with the first separator sheet 2 (contacting the deflection roll 51 via the first separator sheet 2). However, the posture of the scraper 52, the location on the scraper 52 that makes contact with the deflection roll 51, and the location on the deflection roll 51 that makes contact with the scraper 52 are not limited, as long as the negative electrode sheet 3 can be peeled off from the first separator sheet 2.

As illustrated in FIG. 5, the negative electrode sheet recovery section 70 includes a guide plate 71 disposed below the scraper 52 and extending to the left of the scraper 52. The negative electrode sheet 3, which has been separated by the first separation device 50 and rests on the upper face 52U of the scraper 52, is transported onto the guide plate 71 as the first separator sheet 2 is transported by the first transporting unit 40. The guide plate 71 slopes downward toward the left. As illustrated in FIG. 2, a negative electrode sheet collection box 72 is provided below a left end of the guide plate 71. When the negative electrode sheet 3 passes over the guide plate 71, the negative electrode sheet 3 is collected in the negative electrode sheet collection box 72.

### Second Gripping Unit

The second gripping unit 130, configured to grip the second separator sheet 4, is configured similarly to the first gripping unit 30, which is configured to grip the first separator sheet 2. As illustrated in FIG. 3, the second gripping unit 130 includes a pair of second clamps 131 and a second moving device 132. The pair of second clamps 131 grips the second separator sheet 4 (positive electrode laminated sheet 5S). The pair of second clamps 131 includes a front clamp 131F, and a rear clamp 131Rr disposed rearward of the front clamp 131F.

The second moving device 132 is configured to move the pair of second clamps 131 along the predetermined transport path R2 of the second separator sheet 4 (see FIG. 2). The meaning of “along transport path R2” is the same as for the transport path R1 of the first separator sheet 2. The second moving device 132 includes a support unit 132a equipped with a pivot device 132a1 configured to pivot the pair of second clamps 131, an up-down guide 132b configured to support the support unit 132a movably in the up-down direction, a left-right guide 132c (see FIG. 2) configured to support the up-down guide 132b movably in the left-right direction, an up-down movement motor 132d (see FIG. 2) configured to move the support unit 132a along the up-down guide 132b, and a left-right movement motor 132e (see FIG. 2) configured to move the up-down guide 132b along the left-right guide 132c. The pivot device 132a1 includes a pivot motor 132a2 including a rotation shaft that rotates about an axis A2 that is offset from base ends (here, the right ends) of the pair of second clamps 131 when viewed in the front-rear direction. The pivot device 132a1 allows the posture of the pair of second clamps 131 to be changed. The second gripping unit 130 grips the second separator sheet 4 with the pair of second clamps 131 and moves the pair of second clamps 131 by the second movement device 132 to pull the second separator sheet 4.

### Second Transportation Unit

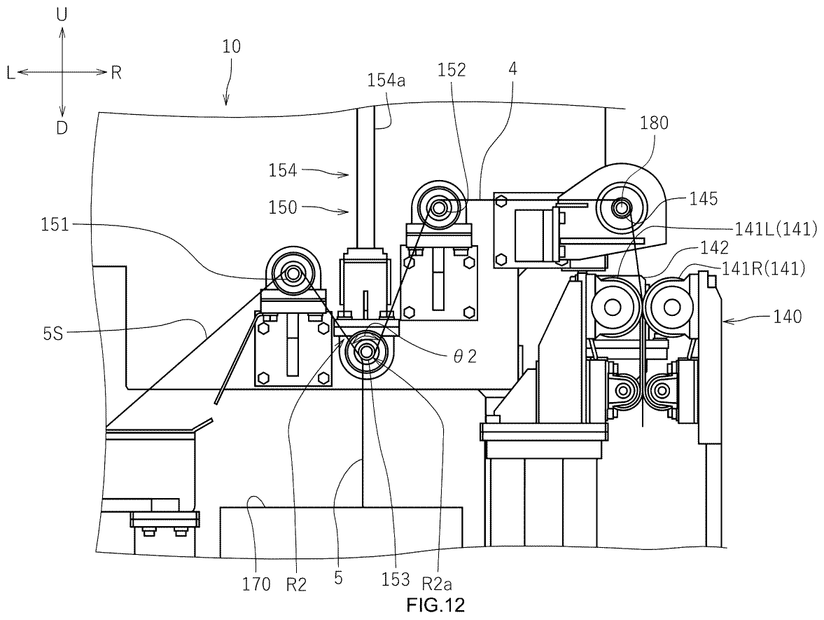

The second transport unit 140, configured to transport the second separator sheet 4, is configured similarly to the first transport unit 40 configured to transport the first separator sheet 2. As illustrated in FIG. 2, the second transport unit 140 includes the pair of nip rolls 141 configured to rotate while gripping the second separator sheet 4. The pair of nip rolls 141 includes a drive roll 141L, and a driven roll 141R disposed facing the drive roll 141L to the right of the drive roll 141L. The second transport unit 140 includes a transport motor 142 (see FIG. 12) configured to rotate the drive roll 141L. The transport motor 142 is a motor capable of controlling rotation speed or rotation torque. For example, the transport motor 142 is a servo motor. The second transport unit 140 further includes a gripping cylinder 143 configured to move the driven roll 141R in the left-right direction to move the driven roll 141R closer to or farther away from the drive roll 141L. A deflection roll 145 is provided above the drive roll 141L and the driven roll 141R. The deflection roll 145 deflects the transport path R2 of the second separator sheet 4, which was previously substantially horizontal, in a substantially up-down direction, directing it toward the drive roll 141L and the driven roll 141R.

The second transport unit 140 drives the clamping cylinder 143 while the second separator sheet 4 is positioned between the drive roll 141L and the driven roll 141R, thereby clamping the second separator sheet 4 between the drive roll 141L and the driven roll 141R (see FIG. 11). When the transport motor 142 is driven, the drive roll 141L rotates such that the side facing the driven roll 141R moves downward, conveying the second separator sheet 4 downward together with the driven roll 141R. The second transport unit 140 is an example of a second pulling device configured to pull the second separator sheet 4. However, the second pulling device is not limited to a device including a pair of nip rolls. The second pulling device may include, for example, a winding roll for winding up the second separator sheet 4 or an arm for pulling the second separator sheet 4. A second separator recovery section 160 is provided below the drive roll 141L and the driven roll 141R.

### Second Separation Device

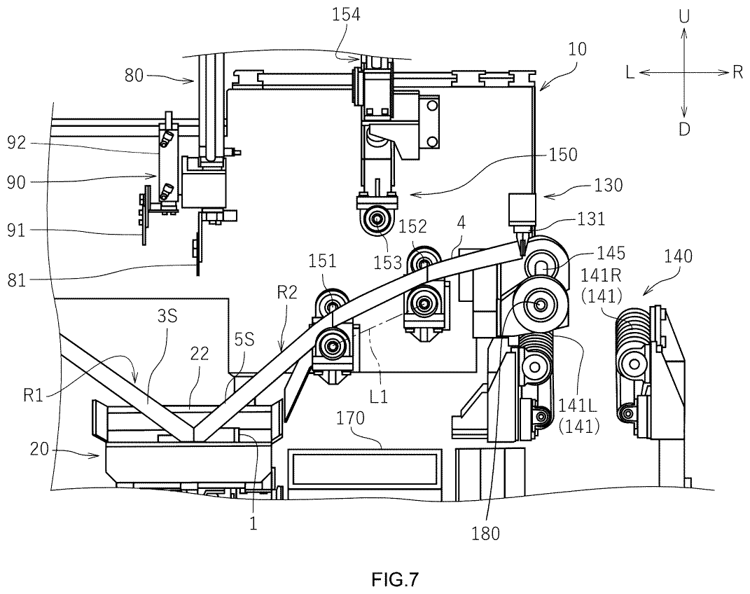

The second separation device 150 is configured to separate the second separator sheet 4 from the positive electrode sheet 5 on the transport path R2 of the second separator sheet 4, upstream of the second transport unit 140. FIG. 7 is a perspective view of the second separation device 150. Note that FIG. 7 shows a state during the process of winding the second separator sheet 4 onto the second separation device 150. As illustrated in FIG. 7, the second separation device 150 includes an upstream roll 151, a downstream roll 152, a peeling roll 153 (see also FIG. 12; FIG. 12 illustrates the peeling roll 153 with its bearing removed for making the peeling roll 153 easier to see), and a roll lowering device 154.

The upstream roll 151 is disposed on the transport path R2 of the second separator sheet 4, and the second separator sheet 4 (positive electrode laminated sheet 5S) is wound onto the upstream roll 151. The upstream roll 151 extends in the front-rear direction. The upstream roll 151 is configured to rotate about an axis of rotation extending in the front-rear direction. In this embodiment, the upstream roll 151 is disposed to the right and above the rotary box 22 of the electrode assembly housing section 20. The second separator sheet 4 (positive electrode laminated sheet 5S) is wound onto the upstream roll 151 from above by the second gripping unit 130. Between the electrode assembly housing section 20 and the upstream roll 151, the second separator sheet 4 (positive electrode laminated sheet 5S) is conveyed diagonally upward to the right.

The downstream roll 152 is disposed downstream of the upstream roll 151 on the transport path R2 of the second separator sheet 4, and the second separator sheet 4 is wound onto the downstream roll 152. In this embodiment, the downstream roll 152 is disposed to the right and above the upstream roll 151. The downstream roll 152 extends in the front-rear direction. The downstream roll 152 is configured to rotate about an axis of rotation extending in the front-rear direction. The second separator sheet 4 is wound onto the downstream roll 152 from below by the second gripping unit 130. The downstream roll 152 is disposed at substantially the same height as the deflection roll 145 of the second transport unit 140. Between the downstream roll 152 and the deflection roll 145, the second separator sheet 4 is conveyed in a substantially horizontal direction.

The peeling roll 153 is disposed between the upstream roll 151 and the downstream roll 152 in the left-right direction. The peeling roll 153 is disposed on the transport path R2 of the second separator sheet 4. The peeling roll 153 is a roll that deflects the transport path R2 to separate the positive electrode sheet 5 from the second separator sheet 4. The peeling roll 153 extends in the front-rear direction. The peeling roll 153 rotates about an axis of rotation extending in the front-rear direction.

The roll lowering device 154 is configured to lower the peeling roll 153, moving it below a line L1 connecting the upstream roll 151 and the downstream roll 152. In this embodiment, the roll lowering device 154 moves the peeling roll 153 downward such that it collides with the second separator sheet 4. Further, the roll lowering device 154 is configured to raise the peeling roll 153, moving it above the line L1 connecting the upstream roll 151 and the downstream roll 152. As illustrated in FIG. 2, the roll lowering device 154 includes an air cylinder 154a that extends and retracts in the up-down direction. However, the configuration of the roll lowering device 154 is not limited to this. For example, the roll lowering device 154 may include a motor configured to raise and lower the peeling roll 153.

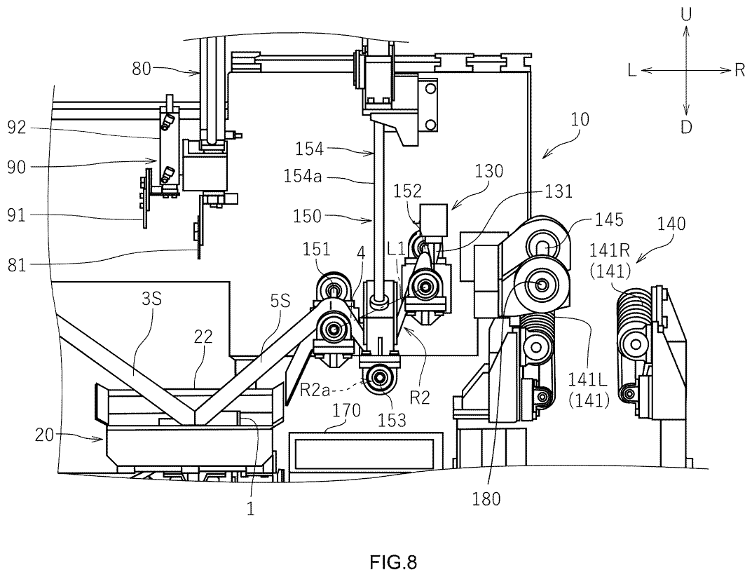

FIG. 8 is a perspective view of the second separation device 150 with the peeling roll 153 lowered. As illustrated in FIG. 8, when the roll lowering device 154 is driven with the positive electrode laminated sheet 5S wound onto the upstream roll 151 and the downstream roll 152, and the peeling roll 153 is lowered below the line L1, the peeling roll 153 deflects the transport path R2 into a V-shape. With the transport path R2 having a V-shape, the positive electrode sheet 5 separates from the second separator sheet 4 (see also FIG. 12). The positive electrode sheet recovery section 170 is disposed below the peeling roll 153 to recover the positive electrode sheet 5. An angle θ2 (see FIG. 12; θ2 represents the interior angle, and a smaller θ2 indicates a sharper bend) at which the transport path R2 is deflected by the peeling roll 153 is not particularly limited, and is, for example, 60 degrees or less. Reference numeral R2a indicates the portion of the transport path R2 that is deflected (the deflected portion) by the peeling roll 153.

Note that, the upstream roll 151 and the downstream roll 152 may be arranged in a direction other than the left-right direction, for example, in the up-down direction. The direction of movement of the peeling roll 153 is not particularly limited as long as it intersects the line connecting the upstream roll 151 and the downstream roll 152.

### Tension Detection Device

The tension detection device 180 detects tension of the second separator sheet 4 pulled by the second transport unit 140. In this embodiment, the tension detection device 180 is provided on the deflection roll 145 that deflects the transport path R2 of the second separator sheet 4 in a substantially vertical direction. Here, the tension detection device 180 measures a force with which the deflection roll 145 is pressed downward by the second separator sheet 4. However, the location where the tension detection device 180 is provided is not limited to the deflection roll 145. For example, the tension detection device 180 may detect tension applied to the second separator sheet 4 by acquiring a rotational torque of the transport motor 142 of the second transport unit 140. The tension detection device 180 may be configured to detect tension of the first separator sheet 2 pulled by the first transport unit 40. The electrode assembly disassembly device 10 may include both a tension detection device configured to detect tension of the first separator sheet 2 pulled by the first transport unit 40 and a tension detection device configured to detect tension of the second separator sheet 4 pulled by the second transport unit 140.

### Impact Application Device

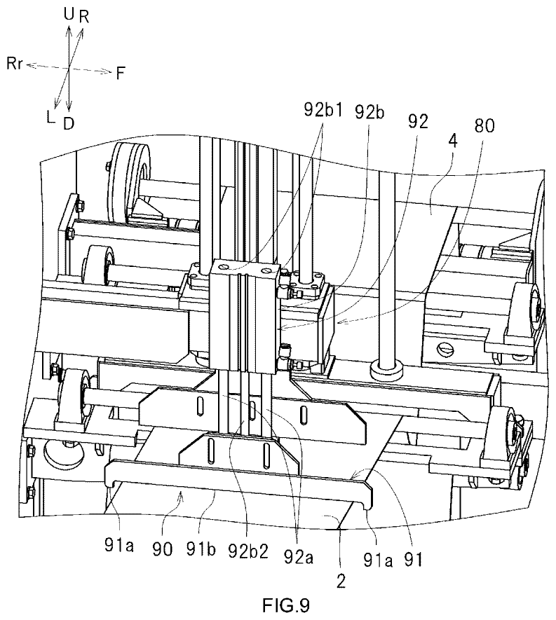

The impact application device 90 is disposed above the electrode assembly housing section 20 and to the left of the center scraper 81 of the positive/negative electrode separation device 80 (on the side of the first transport unit 40). FIG. 9 is a perspective view illustrating the impact application device 90. As illustrated in FIG. 9, the impact application device 90 includes the moving bar 91, and a bar lifting device 92 configured to move the moving bar 91 in the up-down direction. The bar lifting device 92 moves the moving bar 91 to collide with the first separator sheet 2. FIG. 9 illustrates a state where the moving bar 91 has collided with the first separator sheet 2. Note that, the impact application device 90 may also move the moving bar 91 to collide with the second separator sheet 4. In this case, the impact imparting device 90 may be provided above the electrode assembly housing section 20 and to the right of the center scraper 81 of the positive/negative electrode separation device 80 (on the side of the second transport unit 140). Alternatively, the impact imparting device 90 may be configured to impart to both the first separator sheet 2 and the second separator sheet 4.

As illustrated in FIG. 9, the moving bar 91 has a flat plate-like shape extending in the width direction of the first separator sheet 2 (here, the front-rear direction) and the up-down direction. The length of the moving bar 91 in the front-rear direction is longer than the width of the first separator sheet 2. A lower end portion of the moving bar 91 is configured in a U-shape, where, in a side view, both front and rear ends protrude downward more than the central portion. Front and rear protrusions 91a of the moving bar 91 are disposed respectively forward and rearward of the first separator sheet 2 on the transport path R2. A contact portion 91b is provided between the front and rear protrusions 91a. The contact portion 91b is configured to be flat. The length of the contact portion 91b in the front-rear direction is longer than the width of the first separator sheet 2. The contact portion 91b comes into contact with the first separator sheet 2 when the moving bar 91 collides with the first separator sheet 2. The front and rear pair of protrusions 91a prevent the first separator sheet 2 from moving in the front-rear direction when the moving bar 91 collides with the first separator sheet 2.

As illustrated in FIG. 9, in this embodiment, the bar lifting device 92 includes a pair of front-rear guide rods 92a and a lifting cylinder 92b. The pair of guide rods 92a each extend in the up-down direction. The pair of guide rods 92a are inserted into a pair of front-rear guide holes 92b1 formed in the lifting cylinder 92b. The pair of guide rods 92a is configured to move in the up-down direction within the pair of guide holes 92b1. The lifting cylinder 92b includes a rod 92b2 that extends and retracts in the up-down direction. In this embodiment, the lifting cylinder 92b is an air cylinder. The moving bar 91 is fixed to lower ends of the pair of guide rods 92a and to a lower end of the rod 92b2. By driving the lifting cylinder 92b, the moving bar 91 moves in the up-down direction, approaching or moving away from the first separator sheet 2.

However, the impact application device 90 is not limited to this configuration. For example, the shape of the moving bar 91 is not limited to the shape described above. The moving bar 91 may, for example, be cylindrical. For example, the bar lifting device 92 may include an electric motor instead of an air cylinder. For example, during the descent of the moving bar 91, the bar lifting device 92 may allow the moving bar 91 to fall under its own weight.

### Controller

The controller 100 (see FIG. 2) is connected to and controls the air cylinder 23b of the fixture lowering device 23, the pair of first clamps 31, the pivot motor 32a2, the up-down movement motor 32d, and the left-right movement motor 32e of the first gripping unit 30, the transport motor 42 and the gripping cylinder 43 of the first transport unit 40, the insertion cylinder 53b of the scraper insertion device 53, the pair of second clamps 131, the pivot motor 132a2, the up-down movement motor 132d, and the left-right movement motor 132e of the second gripping unit 130, the transport motor 142 and the gripping cylinder 143 of the second transport unit 140, the air cylinder 154a of the roll lowering device 154, the air cylinder 82a of the scraper lowering device 82, and the lifting cylinder 92b of the impact application device 90. Further, the controller 100 is connected to the tension detection device 180 and receives signals corresponding to the tension of the second separator sheet 4 transmitted by the tension detection device 180. The controller 100 controls each member and performs the operations described below during the disassembly process of the electrode assembly 1.

The configuration of the controller 100 is not particularly limited. The controller 100 may, for example, include a microcomputer. The microcomputer may include, for example, an interface (I/F) for receiving data and the like from an external device, a central processing unit (CPU) that executes program instructions, a read-only memory (ROM) storing the program executed by the CPU, and a random access memory (RAM) used as a working area for executing the program, and a storage device such as a memory for storing the program and various data. The controller 100 may, for example, include a programmable controller.

### Electrode Assembly Disassembly Process

Now, an example process for disassembling an electrode assembly 1 using the electrode assembly disassembly device 10 according to this embodiment will be described.

### Separation of Negative Electrode and Positive Electrode

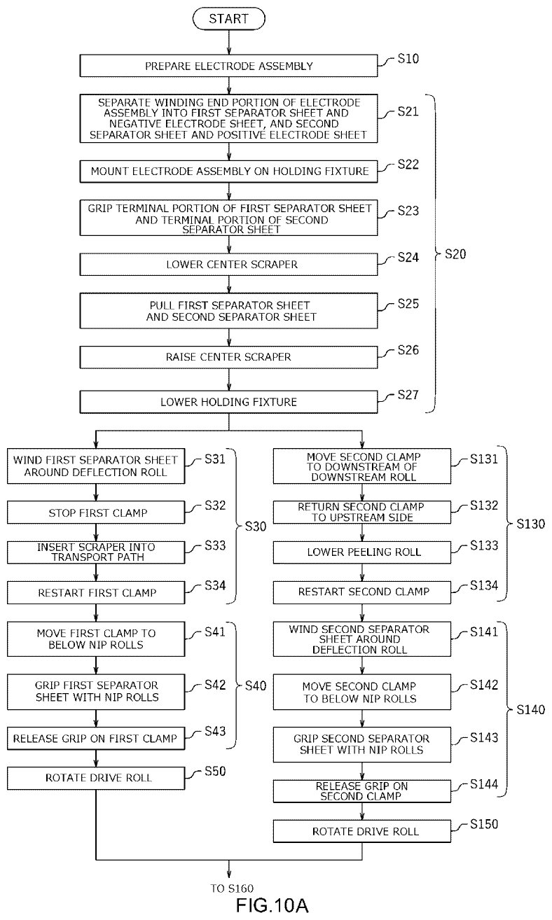

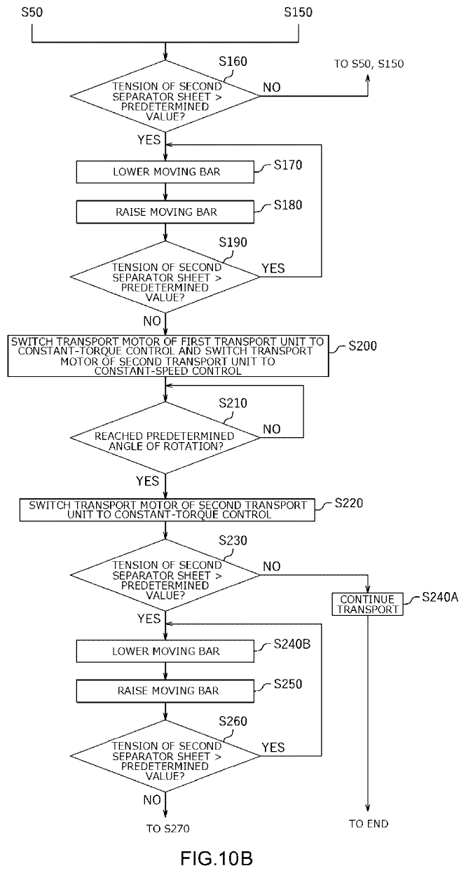

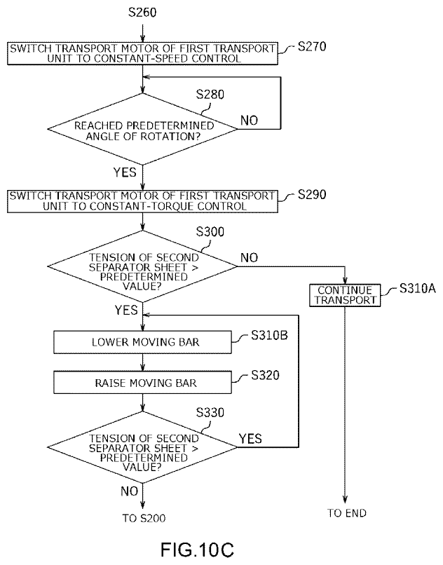

FIGS. 10A to 10C are flowcharts showing the disassembly process of the electrode assembly 1. As illustrated in FIG. 10A, in an electrode assembly preparation step S10, the electrode assembly 1 is prepared. In a positive and negative electrode separation step S20, the electrode assembly 1 is separated at its winding end portion into the first separator sheet 2 and the negative electrode sheet 3, and the second separator sheet 4 and the positive electrode sheet 5. Further, in the positive and negative electrode separation step S20, the electrode assembly 1 is unwound by pulling the first separator sheet 2 and the second separator sheet 4, respectively, and the electrode assembly 1 is separated into the negative electrode laminated sheet 3S, which is a laminated sheet of the first separator sheet 2 and the negative electrode sheet 3, and the positive electrode laminated sheet 5S, which is a laminated sheet of the second separator sheet 4 and the positive electrode sheet 5. As illustrated in FIG. 10A, the positive and negative electrode separation step S20 includes a terminal portion processing step S21, an electrode assembly mounting step S22, a gripping step S23, a center scraper lowering step S24, a pulling step S25, a center scraper raising step S26, and a fixture lowering step S27.

In the terminal portion processing step S21, the electrode assembly 1 is separated at its winding end portion into the first separator sheet 2 and the negative electrode sheet 3, and the second separator sheet 4 and the positive electrode sheet 5. The terminal portion processing step S21 varies depending on the terminal processing of the electrode assembly 1. For example, the terminal portion processing step S21 involves peeling off the tape attached to the terminal, folding the terminal portion of the first separator sheet 2 to the left, and folding the terminal portion of the second separator sheet 4 to the right.

In the electrode assembly mounting step S22, the electrode assembly 1, which has undergone the terminal portion processing step S21, is mounted onto the holding fixture 21. In the electrode assembly mounting step S22, the terminal portion of the first separator sheet 2 is placed onto the first placement portion 21b of the holding fixture 21 (see FIG. 3). Also, in the electrode assembly mounting step S22, the terminal portion of the second separator sheet 4 is placed on the second placement portion 21c of the holding fixture 21 (see FIG. 3). While the terminal portion processing step S21 and the electrode assembly mounting step S22 may be performed manually, the terminal portion processing step S21 and the electrode assembly mounting step S22 may also be performed by an automatic or semi-automatic device. The terminal portion processing step S21 may be performed while the electrode assembly 1 is housed in the holding fixture 21.

In the gripping step S23, the pair of first clamps 31 grip the terminal portion of the first separator sheet 2, and the pair of second clamps 131 grip the terminal portion of the second separator sheet 4 (see FIG. 3). In the center scraper lowering step S24, the center scraper 81 is lowered and inserted between the negative electrode laminated sheet 3S and the positive electrode laminated sheet 5S (see FIG. 3). In the pulling step S25, the first separator sheet 2 held by the pair of first clamps 31 is pulled diagonally upward to the left by the first moving device 32, and the second separator sheet 4 held by the pair of second clamps 131 is pulled diagonally upward to the right by the second moving device 132 (see FIG. 4). In the center scraper raising step S26, the center scraper 81 is raised and retracted from the holding fixture 21. In the fixture lowering step S27, the holding fixture 21 is lowered. This allows the electrode assembly 1 to rotate freely.

### Recovery of First Separator Sheet and Negative Electrode Sheet

In the negative electrode separation step S30, the negative electrode laminated sheet 3S is wound onto the deflection roll 51 to deflect the transport path R1 of the first separator sheet 2. Also, the plate-like scraper 52 is inserted into the deflected portion R1a of the transport path R1, and the first separator sheet 2 and the negative electrode sheet 3 are separated between the side of a first surface of the scraper 52 (here, the lower face 52D) and the side of a second surface of the scraper 52 (here, the upper face 52U). More specifically, as illustrated in FIG. 10A, the negative electrode separation step S30 includes a winding step S31, a clamp stop step S32, a scraper insertion step S33, and a clamp restart step S34.

In the winding step S31, the pair of first clamps 31 are moved to the upper and left side of the deflection roll 51, and then further moved to the lower and left side of the deflection roll 51, thereby winding the first separator sheet 2 onto the deflection roll 51 (see FIG. 4). In the clamp stop step S32, the movement of the pair of first clamps 31 is stopped. At the point of clamp stop step S32, only the first separator sheet 2 among the negative electrode laminated sheets 3S is wrapped around the deflection roll 51. At this time, the negative electrode sheet 3 is positioned upstream of the deflection roll 51 on the transport path R1. By stopping the pair of first clamps 31 below and to the left of the deflection roll 51 in the vicinity of the deflection roll 51 (stopping them immediately after winding the first separator sheet 2 onto the deflection roll 51), the negative electrode sheet 3 can be positioned upstream of the deflection roll 51 on the transport path R1, regardless of the distance between the terminal portion of the first separator sheet 2 and the terminal portion of the negative electrode sheet 3 in the disassembled electrode assembly 1.

In the scraper insertion step S33, the scraper 52 is moved to the right and inserted into the deflected portion R1a of the transport path R1. In the negative electrode separation step S30, the scraper 52 is inserted into the transport path R1 from outside the transport path R1 after the tip portion of the first separator sheet 2 has passed through the deflected portion R1a of the transport path R1 and before the tip portion of the negative electrode sheet 3 reaches the deflected portion R1a of the transport path R1. In this embodiment, the scraper 52 is inserted into the transport path R1 from outside the transport path R1 while the movement of the pair of first clamps 31 is stopped.

In the clamp restart step S34, the pair of first clamps 31 are moved downward. This causes the negative electrode laminated sheet 3S to unwind again, and the negative electrode sheet 3 becomes slightly wound onto the deflection roll 51. When the negative electrode sheet 3 becomes partially wound around the deflection roll 51, the stiffness of the negative electrode sheet 3 causes its terminal portion (the leading edge portion in the direction of movement) to peel away from the first separator sheet 2. However, the negative electrode sheet 3, which includes the negative electrode current collector foil 3a made of copper foil, has weaker stiffness and is more prone to bending than the positive electrode current collector foil 5a made of aluminum foil. Further, the adhesive force between the negative electrode sheet 3 and the first separator sheet 2 is stronger than the adhesive force between the positive electrode sheet 5 and the second separator sheet 4. Thus, separation between the negative electrode sheet 3 and the first separator sheet 2 does not necessarily progress further. Therefore, in the scraper insertion step S33, the scraper 52 is inserted into the deflected portion R1a of the transport path R1 of the first separator sheet 2.

Through the clamp restart step S34, the negative electrode sheet 3 is moved to a point where the tip portion 52R of the scraper 52 is located. As a result, the tip portion 52R of the scraper 52 is inserted between the first separator sheet 2 and the peeled-back negative electrode sheet 3 (see FIG. 6). As the first separator sheet 2 is conveyed downstream along the transport path R1, the negative electrode sheet 3 is sequentially peeled away from the first separator sheet 2 by the scraper 52. This continues even after the device transporting the first separator sheet 2 changes to the first transport unit 40.

In the first separator clamping step S40, in step S41, the pair of first clamps 31 are moved downward past the pair of nip rolls 41 of the first transport unit 40. At this time, the pair of first clamps 31 pass between the pair of nip rolls 41. As a result, the first separator sheet 2 is guided between the pair of nip rolls 41. In step S42, the driven roll 41R is moved to the left, and the first separator sheet 2 is gripped between the driven roll 41R and the driven roll 41L. In step S43, the pair of first clamps 31 are opened, releasing the grip on the first separator sheet 2.

In the first separator transport step S50, the drive roll 41L is rotated to transport the first separator sheet 2. FIG. 11 is a perspective view of the first transport unit 40 and the first separation device 50 while transporting the first separator sheet 2. As illustrated in FIG. 11, when the first separator sheet 2 is transported by the first transport unit 40, the first separator sheet 2 and the negative electrode sheet 3 are unwound from the electrode assembly 1, while the first separator sheet 2 and the negative electrode sheet 3 are separated and recovered. At this time, the controller 100 performs constant-speed control on the transport motor 42 such that the transport motor 42 rotates at a predetermined speed.

Although not illustrated in FIG. 10A, during movement of the pair of first clamps 31, the posture of the pair of first clamps 31 is changed appropriately by the rotary device 32a1. Specifically, during the gripping step S23, the pair of first clamps 31 are oriented with their tips facing to the right (see FIG. 3). Subsequently, the pair of first clamps 31 are rotated clockwise 90 degrees in a front view, adopting a posture where their tips face downward. During the winding step S31, the pair of first clamps 31 are rotated counterclockwise 180 degrees in a front view, adopting a posture where their tips face upward (see FIG. 4). This allows the first separator sheet 2 to be smoothly pulled and transported to the first transport unit 40. However, the posture of the pair of first clamps 31 is not limited to the postures described above. If no particular problems arise, the pair of first clamps 31 may simply be supported on the support unit 32a in a rockable manner, or they may be fixed to the support unit 32a in a non-rockable manner.

### Recovery of Second Separator Sheet and Positive Electrode Sheet

In this embodiment, the second separator sheet 4 and the positive electrode sheet 5 are separated and recovered in parallel with the separation and recovery of the first separator sheet 2 and the negative electrode sheet 3.

In the positive electrode separation step S130, the positive electrode laminated sheet 5S is wound onto the peeling roll 153 to deflect the transport path R2 of the second separator sheet 4, thereby separating the positive electrode sheet 5 from the second separator sheet 4. Specifically, as illustrated in FIG. 10A, the positive electrode separation step S130 includes a clamp movement step S131, a clamp return step S132, a roll lowering step S133, and a clamp restart step S134.

In the clamp movement step S131, the pair of second clamps 131 are moved to the right of the downstream roll 152 (downstream of the transport path R2), thereby introducing the second separator sheet 4 above the upstream roll 151 and the downstream roll 152 but below the peel roll 153 (see FIG. 7). In the clamp return step S132, the pair of second clamps 131 are moved back a predetermined distance to the left (upstream of the transport path R2) (see FIG. 8). This causes the positive electrode laminated sheet 5S to slacken and rest on the upstream roll 151 and the downstream roll 152 with no tension.

In the roll lowering step S133, the peeling roll 153 is lowered to below the upstream roll 151 and the downstream roll 152. This causes the positive electrode laminated sheet 5S to be wound onto the peeling roll 153. As a result, as illustrated in FIG. 8, the transport path R2 of the second separator sheet 4 is deflected into a V-shape by the peeling roll 153.

The positive electrode sheet 5 includes the positive electrode current collector foil 5a made of aluminum foil and possesses a certain degree of stiffness. Further, the positive electrode sheet 5 does not adhere strongly to the second separator sheet 4. For these reasons, the positive electrode sheet 5 separates from the second separator sheet 4 due to the bend in the transport path R2.

In the clamp restart step S134, the pair of second clamps 131 is moved to the right again. As the pair of second clamps 131 moves, the positive electrode sheet 5 is sequentially peeled off at the deflected portion R2a of the transport path R2. This remains the same even after the device transporting the second separator sheet 4 changes to the second transport unit 140.

In the second separator gripping step S140, in step S141, the pair of second clamps 131 is moved via the top of the deflection roll 145 to a position to the right of and below the deflection roll 145. This causes the second separator sheet 4 to be wrapped around the deflection roll 145. In step S142, the pair of second clamps 131 is moved downward past the pair of nip rolls 141 of the second transport unit 140. At this time, the pair of second clamps 131 pass between the pair of nip rolls 141. As a result, the second separator sheet 4 is guided between the pair of nip rolls 141. In step S143, the driven roll 141R is moved to the left, and the drive roll 141L and the driven roll 141R clamp the second separator sheet 4. In step S144, the pair of second clamps 131 are opened, releasing the grip on the second separator sheet 4.

In the second separator transport step S150, the drive roll 141L is rotated to transport the second separator sheet 4. FIG. 12 is a front view of the second transport unit 140 and the second separation device 150 while transporting the second separator sheet 4. As illustrated in FIG. 12, when the second separator sheet 4 is transported by the second transport unit 140, the second separator sheet 4 and the positive electrode sheet 5 unwind from the electrode assembly 1, and the second separator sheet 4 and the positive electrode sheet 5 are separated and recovered. At this time, the controller 100 performs constant-speed control on the transport motor 142 such that the transport motor 142 rotates at a predetermined speed.

Although not illustrated in FIG. 10A, similar to the movement of the pair of first clamps 31, during the movement of the pair of second clamps 131, the posture of the pair of second clamps 131 is changed appropriately by the rotary device 132a1. Specifically, during the gripping step S23, the pair of second clamps 131 are positioned with their tips facing left (see FIG. 3). Subsequently, the pair of second clamps 131 are rotated counterclockwise 90 degrees in a front view, adopting a posture where their tips face downward (see FIG. 7). In step S141 (winding the second separator sheet 4 onto the deflection roll 145), the pair of second clamps 131 are rotated clockwise 180 degrees in the front view, adopting a posture where their tips face upward.

### Unwinding of Innermost Circumferential Portion

The controller 100 performs control to unwind a region near an innermost circumferential portion of the winding of the electrode assembly 1 (hereinafter referred to as “innermost circumferential portion”) in a latter stage of the unwinding process (hereinafter also referred to as “peeling control”). The innermost circumferential portion refers to a portion spanning several revolutions, such as five revolutions, from the initial winding point where, for example, stacked the first separator sheet 2, the negative electrode sheet 3, the second separator sheet 4, and the positive electrode sheet 5 are first wound. The controller 100 initiates the peeling control after the unwinding of the electrode assembly 1 stops and tension is applied to the first separator sheet 2 and the second separator sheet 4, which is typically before unwinding the innermost circumferential portion. However, the peeling control may not be performed if the unwinding of the electrode assembly 1 does not stall.

As illustrated in FIG. 10B, in step S160 of the process of disassembling the electrode assembly 1, it is determined whether the tension of the second separator sheet 4, detected by the tension detection device 180, has exceeded a predetermined tension. If the tension of the second separator sheet 4 has not exceeded the predetermined tension (when the result of step S160 is NO), steps S50 and S150 continue. If the tension of the second separator sheet 4 exceeds the predetermined tension (when the result of step S160 becomes YES), in step S170, the moving bar 91 is lowered to collide with the already unwound and pulled first separator sheet 2.

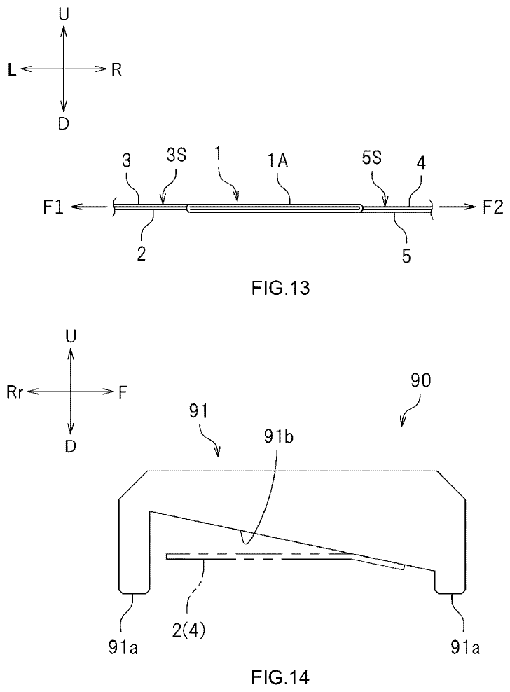

FIG. 13 is a schematic front view of the electrode assembly 1 with tension applied to the second separator sheet 4. As illustrated in FIG. 13, when the tension of the second separator sheet 4 exceeds a predetermined tension, the first separator sheet 2 and the second separator sheet 4 are pulled in opposite directions relative to each other. As a result, a not-yet-unwound portion of the electrode assembly 1 (typically the innermost circumferential portion, hereinafter also referred to as “the unseparated portion 1A”) is suspended by the already unwound first separator sheet 2 and second separator sheet 4. At this time, the unseparated portion 1A is in a state where unwinding is difficult. In the state illustrated in FIG. 13, a force line F1 representing the force tensioning the first separator sheet 2 and a force line F2 representing the force tensioning the second separator sheet 4 substantially overlap. Thus, little force is generated to rotate the unseparated portion 1A, making it difficult to peel apart the bonded negative electrode laminated sheet 3S and positive electrode laminated sheet 5S. Consequently, unwinding of the electrode assembly 1 does not proceed as before. Because the electrode assembly 1 can no longer be unwound, a tension exceeding the predetermined tension is applied to the second separator sheet 4.

When unwinding a portion near an outer peripheral surface of the electrode assembly 1, the thickness of the electrode assembly 1 causes the force line F1 and the force line F2 to shift in the thickness direction of the electrode assembly 1. Consequently, when unwinding the portion near the outer peripheral surface of the electrode assembly 1, rotational force tends to be generated in the electrode assembly 1.

Returning to FIG. 10B, in step S170, when the moving bar 91 collides with the first separator sheet 2, an impact is applied to the bonded area between the negative electrode laminated sheet 3S and the positive electrode laminated sheet 5S at the unseparated portion 1A. This impact generates a force that peels apart the bonded area between the negative electrode laminated sheet 3S and the positive electrode laminated sheet 5S. In step S180, the moving bar 91 is raised to separate it from the first separator sheet 2.

In step S190, it is determined whether the tension of the second separator sheet 4 detected by the tension detection device 180 still exceeds a predetermined tension. If the tension of the second separator sheet 4 exceeds the predetermined tension (when the result of step S190 is YES), it is determined that the peeling of the negative electrode laminated sheet 3S and the positive electrode laminated sheet 5S has not progressed at the unseparated portion 1A. In this case, the process returns to step S170, and the moving bar 91 is lowered again to collide with the first separator sheet 2. Steps S170 to S190 are repeated until the result of step S190 becomes NO.

In step S190, if the tension of the second separator sheet 4 does not exceed the predetermined tension (when the result of step S190 is NO), at the unseparated portion 1A, the peeling of the negative electrode laminated sheet 3S from the positive electrode laminated sheet 5S progresses, and it is determined that either only the weight of the unseparated section 1A is applied to the negative electrode laminated sheet 3S and the positive electrode laminated sheet 5S, or the negative electrode laminated sheet 3S and the positive electrode laminated sheet 5S are separated. In this case, in step S200, the control of the transport motor 42 of the first transport unit 40 is switched to constant-torque control, which rotates the transport motor 42 with a constant torque. As a result, the first transport unit 40 is driven under constant-torque control, and the second transport unit 140 is driven under constant-speed control. Consequently, if the unseparated portion 1A is unwound in step S190, the first separator sheet 2 and the second separator sheet 4 are transported by the first transport unit 40 and the second transport unit 140, respectively. If the unseparated portion 1A is not yet fully unwound in step S190, the first separator sheet 2 and the second separator sheet 4 are pulled again. Further, if the control of the first transport unit 40 switches to constant-torque control while the unwinding of the unseparated portion 1A is incomplete, the transport motor 142 of the second transport unit 140 attempts to rotate at a constant speed by increasing its torque, while the transport motor 42 of the first transport unit 40 rotates at a predetermined torque. Consequently, the unseparated portion 1A of the electrode assembly 1 is pulled by the second transport unit 140 and moves to the right.

In step S210, it is determined whether the transport motor 142 of the second transport unit 140 has rotated by a predetermined angle of rotation. In step S210, it may also be determined whether a predetermined time has elapsed since the start of step S200. If the angle of rotation of the transport motor 142 is less than the predetermined angle of rotation (when the result of step S210 is NO), constant-torque control of the transport motor 42 and constant-speed control of the transport motor 142 continue. If the angle of rotation of the transport motor 142 reaches the predetermined angle of rotation (when the result of step S210 becomes YES), in step S220, the control of the transport motor 142 of the second transport unit 140 is also switched to constant-torque control. The set torque of the transport motor 42 and the set torque of the transport motor 142 are set to the same torque here. Thus, if the unseparated portion 1A has not yet been fully unwound by the process in step S190, the unseparated portion 1A stops at the position at the end of step S210. Furthermore, a tension corresponding to the set torques of the transport motors 42 and 142 is applied to the first separator sheet 2 and the second separator sheet 4.

In step S230, it is determined whether the tension of the second separator sheet 4 detected by the tension detection device 180 exceeds a predetermined tension. If the tension of the second separator sheet 4 does not exceed the predetermined tension (when the result of step S230 is NO), it is determined that unwinding of the unseparated portion 1A is complete. In this case, the first transport unit 40 and the second transport unit 140 continue to be driven in step S240A. As a result, the first separator sheet 2 and the second separator sheet 4 are recovered. In this case, the disassembly of the electrode assembly 1 is complete. If the tension of the second separator sheet 4 exceeds the predetermined tension (when the result of step S230 is YES), it is determined that unwinding of the unseparated portion 1A is incomplete. In this case, in step S240B, the moving bar 91 is lowered to collide with the already unwound and pulled the first separator sheet 2. In step S250, the moving bar 91 is raised to separate it from the first separator sheet 2.

In step S260, it is determined whether the tension of the second separator sheet 4 detected by the tension detection device 180 still exceeds the predetermined tension. If the tension of the second separator sheet 4 exceeds the predetermined tension (when the result of step S260 is YES), it is determined that peeling between the negative electrode laminated sheet 3S and the positive electrode laminated sheet 5S has not progressed at the unseparated portion 1A. In this case, the process returns to step S240B, and the moving bar 91 is lowered again to collide with the first separator sheet 2. Steps S240B to S260 are repeated until the result of step S260 becomes NO.

In step S260, if the tension of the second separator sheet 4 does not exceed a predetermined tension (when the result of step S260 is NO), it is determined that unwinding of the unseparated portion 1A has progressed. In this case, in step S270, the control of the transport motor 42 of the first transport unit 40 is switched to constant-speed control. This causes the first transport unit 40 to be driven by constant-speed control and the second transport unit 140 to be driven by constant-torque control. Consequently, if the unseparated portion 1A is unwound in step S260, the first separator sheet 2 and the second separator sheet 4 are transported by the first transport unit 40 and the second transport unit 140, respectively. If the unseparated portion 1A has not yet been fully unwound in step S260, the first separator sheet 2 and the second separator sheet 4 are pulled again. Further, if the control of the first transport unit 40 switches to constant-speed control while the unwinding of the unseparated portion 1A is incomplete, the transport motor 42 of the first transport unit 40 attempts to rotate at a constant speed by increasing its torque, while the transport motor 142 of the second transport unit 140 rotates at a predetermined torque. Consequently, the unseparated portion 1A of the electrode assembly 1 is pulled by the first transport unit 40 and moves to the left.

In step S280, it is determined whether the transport motor 42 of the first transport unit 40 has rotated by a predetermined angle of rotation. In step S280, it may also be determined whether a predetermined time has elapsed since the start of step S270. If the angle of rotation of the transport motor 42 has not reached the predetermined angle of rotation (when the result of step S280 is NO), the constant-speed control of the transport motor 42 and the constant-torque control of the transport motor 142 are continued. If the angle of rotation of the transport motor 42 reaches the predetermined angle of rotation (when the result of step S280 becomes YES), the control of the transport motor 42 of the first transport unit 40 is switched back to constant-torque control. Consequently, if the unseparated portion 1A has not yet been fully unwound in step S260, the unseparated portion 1A stops at the position at the end of step S280. Further, tension corresponding to the set torque of the transport motors 42 and 142 is applied to the first separator sheet 2 and the second separator sheet 4.

In step S300, it is determined whether the tension of the second separator sheet 4 detected by the tension detection device 180 exceeds a predetermined tension. If the tension of the second separator sheet 4 does not exceed the predetermined tension (when the result of step S300 is NO), it is determined that unwinding of the unseparated portion 1A is complete. In this case, the first transport unit 40 and the second transport unit 140 continue to be driven in step S310A. As a result, the first separator sheet 2 and the second separator sheet 4 are recovered. In this case, the disassembly of the electrode assembly 1 is complete. If the tension of the second separator sheet 4 exceeds the predetermined tension (when the result of step S300 is YES), it is determined that unwinding of the unseparated portion 1A is incomplete. In this case, in step S310B, the moving bar 91 is lowered to collide with the first separator sheet 2 that has already been unwound and pulled. In step S320, the moving bar 91 is raised to separate it from the first separator sheet 2.

In step S330, it is determined whether the tension of the second separator sheet 4 detected by the tension detection device 180 still exceeds the predetermined tension. If the tension of the second separator sheet 4 exceeds the predetermined tension (when the result of step S330 is YES), it is determined that the peeling between the negative electrode laminated sheet 3S and the positive electrode laminated sheet 5S has not progressed at the unseparated portion 1A. In this case, the process returns to step S310B, and the moving bar 91 is lowered again to collide with the first separator sheet 2. Steps S310B to S330 are repeated until the result of step S330 becomes NO.

In step S330, if the tension of the second separator sheet 4 does not exceed the predetermined tension (when the result of step S330 is NO), it is determined that unwinding of the unseparated portion 1A has progressed. In this case, the process returns to step S200. That is, the transport motor 42 of the first transport unit 40 is controlled at a constant torque, and the transport motor 142 of the second transport unit 140 is controlled at a constant speed. As a result, if the unseparated portion 1A is unwound in step S330, the first separator sheet 2 and the second separator sheet 4 are transported by the first transport unit 40 and the second transport unit 140, respectively. If the unseparated portion 1A has not yet been fully unwound in step S330, the first separator sheet 2 and the second separator sheet 4 are pulled again, and the unseparated portion 1A moves to the right again.

The separation of the negative electrode laminated sheet 3S and the positive electrode laminated sheet 5S due to impact is repeated until the result of step S230 or S300 becomes NO. During this time, the unseparated portion 1A is alternately moved left and right, ensuring it remains positioned within a range where it does not deviate excessively to either the left or right. This control allows the unseparated portion 1A to be continuously positioned away from the moving bar 91. However, the electrode assembly disassembly device 10 may also include a detection device (e.g., a camera) configured to detect the position of the unseparated portion 1A, and control the position of the unseparated portion 1A based on the position detected by the detection device. [Operational Effects of Embodiment]

Now, the effects achievable by the electrode assembly disassembly device 10 and the method for disassembling the electrode assembly 1 according to this embodiment will be described.

The electrode assembly disassembly device 10 according to this embodiment includes the first transport unit 40 configured to pull the first separator sheet 2, the second transport unit 140 configured to pull the second separator sheet 4, and the impact application device 90 configured to apply an impact to at least one of the first separator sheet 2 pulled by the first transport unit 40 and the second separator sheet 4 pulled by the second transport unit 140. In this embodiment, the impact application device 90 applies an impact to the first separator sheet 2 pulled by the first transport unit 40. The electrode assembly 1 is a wound electrode assembly formed by stacking the strip-like first separator sheet 2, the strip-like negative electrode sheet 3, the strip-like second separator sheet 4, and the strip-like positive electrode sheet 5 in this order and winding the stack in a predetermined winding direction. The negative electrode sheet 3 is adhered to the first separator sheet 2, and the positive electrode sheet 5 is adhered to the second separator sheet 4.

The method for disassembling the electrode assembly 1 according to the present embodiment includes the electrode assembly preparation step S10 of preparing the electrode assembly 1, the positive and negative electrode separation step S20 of separating the electrode assembly 1 into the laminated sheet 3S of the first separator sheet 2 and the negative electrode sheet 3, and the laminated sheet 5S of the second separator sheet 4 and the positive electrode sheet 5 at its winding end portion, and a step of unwinding the electrode assembly 1 by pulling the first separator sheet 2 and the second separator sheet 4, respectively (corresponding to the first separator transport step S50, the second separator transport step S150, and the peeling control steps S160 to S330). The step of unwinding the electrode assembly 1 includes an impact application step of applying an impact to the unwound first separator sheet 2 (corresponding to the steps S170, S240B, and S310B).

According to the electrode assembly disassembly device 10 and the method for disassembling the electrode assembly 1, the impact applied to the unwound first separator sheet 2 generates a force that peels apart the negative electrode laminated sheet 3S and the positive electrode laminated sheet 5S. Thus, it is possible to more effectively unwind regions where the force to rotate the electrode assembly 1 is small and unwinding is difficult, such as a region near the innermost circumference portion of the electrode assembly 1.

In this embodiment, the impact application device 90 includes the moving bar 91 that moves toward the first separator sheet 2, and the bar lifting device 92 that moves the moving bar 91 to collide with the first separator sheet 2. The impact application step (steps S170, S240B, and S310B) includes moving the moving bar 91 toward the unwound first separator sheet 2 and causing it to collide with it.

According to the electrode assembly disassembly device 10 and the method for disassembling the electrode assembly 1, an impact can be applied to the unwound first separator sheet 2 by causing the moving bar 91 to collide with the first separator sheet 2.

### [modification 1]

In a preferred modification of the embodiment described above, the moving bar 91 may be configured to abut against the first separator sheet 2 on one side relative to the width direction of the first separator sheet 2. FIG. 14 is a schematic left side view illustrating the impact application device 90 according to a modification. As illustrated in FIG. 14, in the moving bar 91 of the impact application device 90 according to this modification, the contact portion 91b that makes contact with the first separator sheet 2 (or alternatively the second separator sheet 4) is inclined upward toward the rear. A surface of the moving bar 91 opposing the first separator sheet 2 or the second separator sheet 4 (contact portion 91b) is inclined relative to the first separator sheet 2 or the second separator sheet 4 such that, toward the rear, the surface is farther from the first separator sheet 2 or the second separator sheet 4. However, the contact portion 91b may also be inclined downward toward the rear.

Due to the inclination of the contact portion 91b, the impact application device 90 according to the modification causes the moving bar 91 to collide with one end portion (here, the front end) of the first separator sheet 2 or the second separator sheet 4 in the width direction at least before colliding with the other end portion (here, the rear end). Here, after causing a front end portion of the contact portion 91b to collide with a front end portion of the first separator sheet 2, the impact application device 90 further lowers the moving bar 91, sequentially causing the moving bar 91 to collide toward the rear end portion of the first separator sheet 2. Finally, the impact application device 90 causes the rear end portion of the contact portion 91b to collide with the rear end portion of the first separator sheet 2. However, the impact application device 90 may cause the moving bar 91 to collide with one end portion in the width direction of the first separator sheet 2 or the second separator sheet 4 and not cause the moving bar 91 to collide with the other end portion.

By causing the moving bar 91 to collide with one end portion of the first separator sheet 2 or the second separator sheet 4 in the width direction at least before the other end portion, it is possible to at least temporarily press only one end portion of the first separator sheet 2 or the second separator sheet 4 in the width direction. This allows a twisting force to be applied to the first separator sheet 2 or the second separator sheet 4 in the width direction. This twisting force acts to peel the first separator sheet 2 or the second separator sheet 4 in the width direction from the unseparated portion 1A. Thus, this configuration allows the unseparated portion 1A to be unwound more effectively.

In this modification, the contact portion 91b is inclined relative to the first separator sheet 2 such that, toward one side of the first separator sheet 2 (here, the rear side) in the width direction, the portion is farther from the first separator sheet 2. This configuration allows the moving bar 91 to collide with one end portion of the first separator sheet 2 in the width direction at least before colliding with the other end portion, achievable with a simple structure.

The impact application device 90 may move the moving bar 91, for example, such that it approaches the first separator sheet 2 or the second separator sheet 4 while moving in the width direction of the first separator sheet 2 or the second separator sheet 4, in order to cause the moving bar 91 to collide with one end portion of the first separator sheet 2 or the second separator sheet 4 in the width direction at least before the other end portion. The impact application device 90 may also include, for example, a plurality of movable bodies arranged in the width direction of the first separator sheet 2 or the second separator sheet 4, sequentially pressing the first separator sheet 2 or the second separator sheet 4. The configuration for causing the movable assembly to collide with one end portion of the first separator sheet 2 or the second separator sheet 4 in the width direction at least before the other end portion is not particularly limited.

### [modification 2]

In another preferred modification, the impact application device 90 may be configured to apply an impact to at least one of the first separator sheet 2 and the second separator sheet 4 by bringing a vibrating body into contact with at least one of the first separator sheet 2 and the second separator sheet 4.

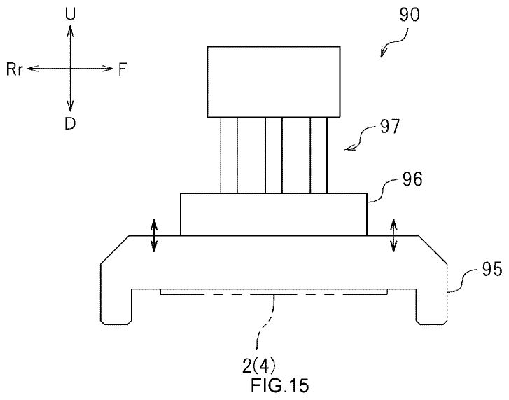

FIG. 15 is a schematic left side view illustrating the impact application device 90 according to a second modification. As illustrated in FIG. 15, the impact application device 90 according to this modification includes a vibrating body 95, a vibration generator 96 configured to vibrate the vibrating body 95, and a vibrating body moving device 97 configured to move the vibrating body 95 and bring it into contact with the first separator sheet 2 (or the second separator sheet 4).

The vibration generator 96 includes, for example, an ultrasonic vibration element. The vibration generator 96 causes the vibrating body 95 to vibrate at a frequency within a predetermined range using the ultrasonic vibration element, for example. The direction in which the vibrating body 95 vibrates is preferably the thickness direction (here, the up-down direction) of the first separator sheet 2. However, the vibration frequency and vibration direction of the vibrating body 95 are not particularly limited. The shape of the vibrating body 95 may be the same as in the first embodiment or the first modification or may be different. The vibrating body 95 may consist of the vibration generator 96 itself. In this case, the vibrating body 95 vibrates using its own driving force.

The configuration of the vibrating body moving device 97 may be the same as in the first embodiment. However, the vibrating body moving device 97 may not be configured to apply an impact to the first separator sheet 2 based on the collision velocity of the vibrating body 95. The vibrating body moving device 97 may press the vibrating body 95 against the first separator sheet 2 at a low speed.

In this modification, the impact application step (steps S170, S240B, and S310B; see FIGS. 10B and 10C) includes bringing the vibrating body 95 into contact with the unwound first separator sheet 2 (or second separator sheet 4).

According to the impact application device 90 of this modification, transmitting vibration from the vibrating body 95 to the first separator sheet 2 (or second separator sheet 4) makes it possible to generate a force that repeatedly and rapidly peels the first separator sheet 2 (or second separator sheet 4) away from the unseparated portion 1A. This facilitates more effective unwinding of the unseparated portion 1A.

### [other Embodiments]

One embodiment of a device for disassembling an electrode assembly and a method for disassembling an electrode assembly proposed herein has been described above. However, the above embodiment is merely one example, and other embodiments are possible.

For example, in the embodiments and modifications described above, the impact application device 90 causes the moving bar 91 or the vibrating body 95 extending in the width direction of the first separator sheet 2 to come into contact with the first separator sheet 2. However, the moving body or the vibrating body may extend in a direction oblique to the width direction of the first separator sheet 2 or the second separator sheet 4. Further, in the embodiments and modifications described above, the impact application device 90 brings the moving bar 91 or the vibrating body 95 into contact with a surface of the strip-like first separator sheet 2. However, the impact application device 90 may cause the moving bar 91 or the vibrating body 95 to come into contact with a side portion of the strip-like first separator sheet 2 or the second separator sheet 4 and press the first separator sheet 2 or the second separator sheet 4 in its width direction. Pressing the first separator sheet 2 or the second separator sheet 4 in its width direction generates a force that shifts the first separator sheet 2 or the second separator sheet 4 laterally away from the unseparated portion 1A. Applying such a shifting force also allows the unseparated portion 1A to be unwound more effectively.

In the above embodiment, the transport path R1 of the first separator sheet 2 and the transport path R2 of the second separator sheet 4 are diverged left and right from the electrode assembly housing section 20. However, the transport path R1 of the first separator sheet 2 and the transport path R2 of the second separator sheet 4 are not particularly limited. Although the transport path R1 of the first separator sheet 2 and the transport path R2 of the second separator sheet 4 diverge in opposite directions immediately after branching, they may be deflected downstream of the branch, for example, such that the negative electrode sheet 3 and the positive electrode sheet 5 are collected on the same side.

The configuration of the first moving device 32 and the second moving device 132 is not particularly limited. The first moving device 32 and the second moving device 132 may, for example, move the first clamp 31 and the second clamp 131 along guide rails laid along a predetermined track. The first moving device 32 and the second moving device 132 may, for example, include a multi-axis robot.

The deflection roll 51, the upstream roll 151, the downstream roll 152, and the peeling roll 153 need not rotate. The peeling roll 153 need not move to collide with the second separator sheet 4 and may be fixed in position.

The embodiment described above does not limit the present invention unless specifically stated. The techniques disclosed herein may be modified in various ways. Each component and each process mentioned herein may be omitted or combined as appropriate to the extent that no specific problems arise. This specification includes the disclosures described in the following items.

### Item 1

A method for disassembling an electrode assembly, the method comprising:
preparing an electrode assembly formed by stacking a strip-like first separator, a strip-like negative electrode, a strip-like second separator, and a strip-like positive electrode in this order and winding the stack in a predetermined winding direction;
separating the electrode assembly into the first separator and the negative electrode, and the second separator and the positive electrode at a winding end portion of the electrode assembly; and
pulling the first separator and the second separator, respectively, to unwind the electrode assembly,
wherein the unwinding includes applying an impact to at least one of the unwound first separator and the unwound second separator.

### Item 2

The method for disassembling an electrode assembly according to item 1, wherein
applying the impact includes moving a moving body and causing the moving body to collide with at least one of the unwound first separator and the unwound second separator.

### Item 3

The method for disassembling an electrode assembly according to item 2, wherein
applying the impact includes causing the moving body to collide with one end portion of the first separator or the second separator in a width direction at least before colliding with the other end portion.

### Item 4

The method for disassembling an electrode assembly according to item 1, wherein
applying the impact includes causing a vibrating body to come into contact with at least one of the unwound first separator and the unwound second separator.

### Item 5

A device for disassembling an electrode assembly configured to disassemble an electrode assembly formed by stacking a strip-like first separator, a strip-like negative electrode, a strip-like second separator, and a strip-like positive electrode in this order and winding the stack in a predetermined winding direction, the device comprising:
a first pulling device configured to pull the first separator;
a second pulling device configured to pull the second separator; and
an impact application device configured to apply impact to at least one of the first separator pulled by the first pulling device and the second separator pulled by the second pulling device.

### Item 6

The device for disassembling an electrode assembly according to item 5, wherein the impact application device includes:
a moving body configured to move toward at least one of the first separator and the second separator; and
a moving device configured to move the moving body and cause the moving body to collide with at least one of the first separator and the second separator.

### Item 7

The device for disassembling an electrode assembly according to item 6, wherein the impact application device causes the moving body to collide with one end portion of the first separator or the second separator in a width direction at least before colliding with other end portion.

### Item 8

The device for disassembling an electrode assembly according to item 7, wherein a surface of the moving body opposing the first separator or the second separator is inclined relative to the first separator or the second separator such that, toward the other end portion in the width direction, the surface is farther from the first separator or the second separator.

### Item 9

The device for disassembling an electrode assembly according to item 5, wherein the impact application device includes:
a vibrating body; and
a moving device configured to move the vibrating body and cause the vibrating body to come into contact with at least one of the first separator and the second separator.

What is claimed is:

1. A method for disassembling an electrode assembly, the method comprising:
preparing an electrode assembly formed by stacking a strip-like first separator, a strip-like negative electrode, a strip-like second separator, and a strip-like positive electrode in this order and winding the stack in a predetermined winding direction;
separating the electrode assembly into the first separator and the negative electrode, and the second separator and the positive electrode at a winding end portion of the electrode assembly; and
pulling the first separator and the second separator, respectively, to unwind the electrode assembly,
wherein the unwinding includes applying an impact to at least one of the unwound first separator and the unwound second separator.

2. The method for disassembling an electrode assembly according to claim 1, wherein
applying the impact includes moving a moving body and causing the moving body to collide with at least one of the unwound first separator and the unwound second separator.

3. The method for disassembling an electrode assembly according to claim 2, wherein
applying the impact includes causing the moving body to collide with one end portion of the first separator or the second separator in a width direction at least before colliding with the other end portion.

4. The method for disassembling an electrode assembly according to claim 1, wherein
applying the impact includes causing a vibrating body to come into contact with at least one of the unwound first separator and the unwound second separator.

5. A device for disassembling an electrode assembly configured to disassemble an electrode assembly formed by stacking a strip-like first separator, a strip-like negative electrode, a strip-like second separator, and a strip-like positive electrode in this order and winding the stack in a predetermined winding direction, the device comprising:
a first pulling device configured to pull the first separator;
a second pulling device configured to pull the second separator; and
an impact application device configured to apply impact to at least one of the first separator pulled by the first pulling device and the second separator pulled by the second pulling device.

6. The device for disassembling an electrode assembly according to claim 5, wherein the impact application device includes:
a moving body configured to move toward at least one of the first separator and the second separator; and
a moving device configured to move the moving body and cause the moving body to collide with at least one of the first separator and the second separator.

7. The device for disassembling an electrode assembly according to claim 6, wherein the impact application device causes the moving body to collide with one end portion of the first separator or the second separator in a width direction at least before colliding with other end portion.

8. The device for disassembling an electrode assembly according to claim 7, wherein a surface of the moving body opposing the first separator or the second separator is inclined relative to the first separator or the second separator such that, toward the other end portion in the width direction, the surface is farther from the first separator or the second separator.

9. The device for disassembling an electrode assembly according to claim 5, wherein the impact application device includes:
a vibrating body; and
a moving device configured to move the vibrating body and cause the vibrating body to come into contact with at least one of the first separator and the second separator.
